(19) United States
(12) Patent Application Publication
(10) Pub. No.: US 2025/0008866 A1
(43) Pub. Date: Jan. 9, 2025

(54) Seeding System

(71) Applicant: Precision Planting LLC, Tremont, IL (US)

(72) Inventors: Jeremy J. Hodel, Morton, IL (US); Keith T. Strang, Zimmerman, MN (US); Mitchell R. Dille, Litchfield, MN (US)

(21) Appl. No.: 18/445,671

(22) Filed: Dec. 22, 2023

Related U.S. Application Data
(63) Continuation-in-part of application No. PCT/IB2023/058614, filed on Aug. 31, 2023.
(60) Provisional application No. 63/375,153, filed on Sep. 9, 2022.

(51) Int. Cl. A01C 7/10; A01C 7/12

(52) U.S. Cl. CPC A01C 7/102; A01C 7/127

(57) ABSTRACT

A seed meter and seed delivery apparatus for delivering seed to a furrow in which the seed delivery apparatus orients the seeds.

### CROSS REFERENCE TO RELATED APPLICATIONS

This application is a continuation-in-part of PCT Application No. PCT/IB2023/058614, filed on 31 Aug. 2023, which claims priority to U.S. Patent Application No. 63/375,153, filed on 9 Sep. 2022, the entire contents of all of which are incorporated herein by reference.

### FIELD

Embodiments of the present disclosure relate generally to a seed-delivery device.

### BACKGROUND

Agricultural row crop planters typically include a seed hopper connected to a seed metering system that delivers seeds into a furrow formed by disc opener blades. A plurality of these row crop planters are typically mounted in parallel along a tool bar which is attached to a tractor. For example, it is common as of the time of this filing to have twenty-four, thirty-six, or even forty-eight row units attached to a single tractor.

Within a typical prior art row crop planter, seeds are delivered in bulk from the seed hopper to the metering system. The metering system precisely singulates the bulk seeds, and will most preferably provide these singulated seeds at very predictable and repeatable time intervals. There has been much development of improved metering systems, and these in general have proven to be quite reliable. The row crop planter subsequently delivers one seed at a time into the ground, typically into a furrow cut by the opener blades.

One common prior art method of seed delivery from the seed hopper to the ground is a gravity drop system that locates a seed tube inlet below the seed metering system. A singulated seed drops from the metering system down the seed tube and into a furrow prepared by opener blades disposed forward of the seed tube. This standard method of seed delivery, while a vast improvement over older techniques, leaves room for improvement in desired seed placement and orientation.

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Spacing of seeds can affect yield because plants that are too close together compete for nutrients, and plants too far apart leave wasted space between them. Orientation of seeds can affect time to plant emergence, and therefore, uniformity of plant growth, as well as canopy closure and shading from adjacent plants. It would be beneficial to have improved methods of controlling the position and orientation of seeds placed in trenches so that seeds emerge and grow more uniformly.

There are several methods of orienting seeds for planting. Examples of orientation systems include PCT Publication Nos. WO2018013858A1, WO2018013859A1, WO2018013860A2, and WO2018013861A1. One particular type of seed orienter is described in U.S. Patent Publication No. US2020/0367425A1 and US2022/0192079A1, each which disclose a seed orientation coil. Seed is accelerated with air injected into the coil, and the air is dissipated via at least one vent.

### BRIEF SUMMARY

In some embodiments, a seed-delivery device includes a seed meter having a metering unit configured to receive seeds, a seed conveyor and orientation assembly coupled to the seed meter and having a conveyor belt that receives the singulated seeds, an impeller that moves the singulated seeds through the conveyor belt, a seed orientation apparatus configured to orient the singulated seed in a predetermined orientation, and a seed exit path configured to deposit the singulated and oriented seed into a seed trench.

The seed conveyor and orientation assembly may have a guide having in cross section a seed sliding surface and a guide wall angularly offset from said seed sliding surface, said guide and said seed sliding surface configured to engage said singulated seeds while said singulated seeds are moved through said conveyor belt.

The metering unit may be configured to provide the seeds to the seed conveyor and orientation assembly in a preselected orientation.

The conveyor belt may deliver seeds to a seed orientation device.

The seed orientation device may include a curved seed path, and a pressurized air system to direct an air flow parallel to the curved path.

A row unit for planting seeds includes a frame configured to be coupled to a toolbar, a seed-trench opening assembly carried by the frame and configured to form a seed trench, a seed-delivery device carried by the frame and configured to deliver seeds to the seed trench, and a seed-trench closing assembly carried by the frame and configured to close the seed trench over seeds in the seed trench.

The seed-delivery device may have a seed meter having a metering unit configured to receive seeds, a seed conveyor and orientation assembly coupled to the seed meter and having a conveyor belt that receives the singulated seeds, an impeller that moves the singulated seeds through the conveyor belt, a seed orientation apparatus configured to orient the singulated seed in a predetermined orientation, and a seed exit path configured to deposit the singulated and oriented seed into the seed trench

The seed orientation device may include a curved seed path configured to induce a centrifugal force against the singulated seeds.

In one aspect, a method of planting with a row unit includes forming a seed trench in soil with the row unit, singulating seeds with a metering unit carried by the row unit, transferring singulated seeds from the metering unit to a seed conveyor and orientation assembly, capturing and conveying the singulated seeds between a guide and said impeller, orienting the singulated seeds, dispensing the singulated and oriented seeds from the seed conveyor and orientation assembly into the seed trench, and closing the seed trench with a seed-trench closing assembly.

The seeds may be oriented using a centrifugal force applied to the singulated seed.

In some manifestations, air may be injected into the seed path. In other manifestations, no air is injected.

A seed metering and delivery apparatus may comprise a seed meter. The seed meter may comprise a seed meter disc that may be rotatable about a seed meter disc axis. The seed meter disc may comprise at least a front face that may be configured to move one or more seeds at a seed meter disc speed along a seed supply path to a removal location.

A delivery system may comprise a first seed belt wheel that may be rotatable about a first seed belt wheel axis. The first seed belt wheel may be disposed proximate (e.g., within 6-36 inches, or the like) to the seed meter disc. The delivery system may comprise a second seed belt wheel that may be rotatable about a second seed belt wheel axis. The second seed belt wheel may be distally disposed (e.g., from 0.3 to 6 feet, or the like) from the first seed belt wheel.

The delivery system may comprise a seed belt. The seed belt may be configured to traverse at least a portion of a seed delivery path around the first seed belt wheel and/or the second seed belt wheel. The seed belt may have at least an active surface which may support the one or more seeds and a wheel surface. The first seed belt wheel may be positioned adjacent the front face of the seed meter disc such that at least some of the active surface at least partially crosses the seed supply path at the removal location.

The delivery system may comprise a seed belt housing. The seed belt housing may be positioned to at least partially cover at least a portion of the seed delivery path opposite the active surface of the seed belt. The seed belt housing may comprise at least an exterior surface and an interior surface. The interior surface may be arranged opposite the active surface of the seed belt forming a pocket space between the active surface of the seed belt and the interior surface. The pocket size may be configured to receive and/or accommodate a change in orientation of the one or more seeds.

The seed belt may be configured to receive the one or more seeds from the front face of the seed meter disc which may be carried along the active surface at a seed belt speed. The seed belt may be configured to convey the one or more seeds along at least a portion of the seed delivery path to a delivery discharge location proximate (e.g., from 0.3 to 6 feet, or the like) to the second seed belt wheel.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified side view of a row unit for planting;

FIG. 2 is a simplified right side elevational view of a seed-delivery and orientation apparatus that may be used in the row unit of FIG. 1, in combination with exemplary discs and shank;

FIG. 3 is a simplified right side elevational view of a seed-delivery and orientation apparatus of FIG. 2, but with the discs and shank removed;

FIG. 4 is a simplified partial side elevational view of a seed meter disc and conveyor belt in cooperation, illustrating a seed transfer.

FIG. 5 is a cross-sectional view of the seed conveyor and orientation assembly taken along section line 5′ of FIG. 4.

FIG. 6 is a simplified right side elevational view of a seed-delivery and orientation apparatus similar to that of FIG. 3, but with a twisted central conveyor belt.

FIG. 7A illustrates an example of a seed metering and delivery apparatus with a variable pocket size to convey one or more seeds.

FIG. 7B illustrates an example of a seed metering and delivery apparatus with a variable pocket size to convey one or more seeds.

FIG. 7C illustrates an example of a seed metering and delivery apparatus with a variable pocket size to convey one or more seeds.

FIG. 7D illustrates an example of a seed metering and delivery apparatus with a variable pocket size to convey one or more seeds.

FIG. 7E illustrates an example of a seed metering and delivery apparatus with a variable pocket size to convey one or more seeds.

FIG. 8 illustrates an example of a seed metering and delivery apparatus with components that may affect a pocket size in which the one or more seeds are conveyed.

FIG. 9 illustrates an example of a seed metering and delivery apparatus with one or more components that may affect an orientation of the one or more seeds.

FIG. 10 illustrates an example of a seed metering and delivery apparatus with a range of delivery discharge location orientations for the one or more seeds.

FIG. 11 illustrates an example of a seed metering and delivery apparatus with a sub-furrow opener/trencher for the deposit of the one or more seeds into a subfurrow trench.

FIG. 12 illustrates an example of a seed metering and delivery apparatus with an orientation tube and a sub-furrow opener/trencher for the deposit of the one or more seeds into a subfurrow trench.

FIG. 13 illustrates two cross-sectional views of a seed pocket and seed belt at two different locations on a seed delivery path.

FIG. 14 illustrates two cross-sectional views of a seed pocket and seed belt at two different locations on a seed delivery path.

FIG. 15 illustrates two cross-sectional views of a seed pocket and seed belt at two different locations on a seed delivery path.

FIG. 16 illustrates two cross-sectional views of a seed pocket and seed belt at two different locations on a seed delivery path.

FIG. 17 illustrates a cross-sectional view of a seed pocket and seed belt on a seed delivery path.

### DETAILED DESCRIPTION

All references cited herein are incorporated herein in their entireties. If there is a conflict between a definition herein and in an incorporated reference, the definition herein shall control.

Referring to the drawings, wherein like reference numerals designate identical or corresponding parts throughout the several views.

The illustrations presented herein are not actual views of any planter row unit or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for case of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “about” used in reference to a given parameter is inclusive of the stated value and has the meaning dictated by the context (e.g., it includes the degree of error associated with measurement of the given parameter).

As used throughout, ranges are used as shorthand for describing each and every value that is within the range. Any value within the range can be selected as the terminus of the range.

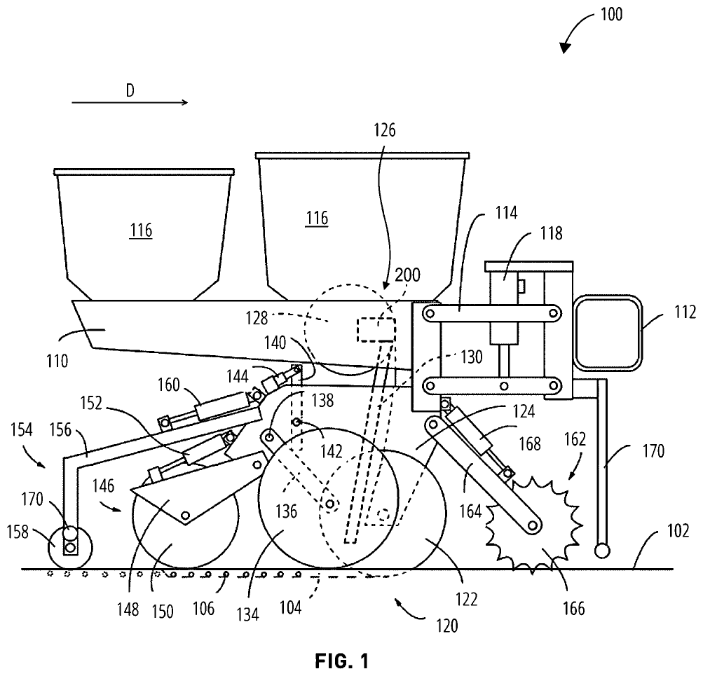

FIG. 1 illustrates an embodiment of an agricultural planter row unit 100. The row unit 100 has a frame 110 pivotally connected to a toolbar 112 by a parallel linkage 114, enabling each row unit 100 to move vertically independently of the toolbar 112 and of other row units 100. The frame 110 operably supports one or more hoppers 116, a downforce control system 118, a seed-trench opening assembly 120, a seed-delivery device 126, a seed-trench closing assembly 146, a packer wheel assembly 154, and a row cleaner assembly 162. The row unit 100 shown in FIG. 1 may be used with a conventional planter or with a central fill planter, in which latter case the hoppers 116 may be replaced with one or more mini-hoppers and the frame 110 modified accordingly as would be recognized by those of skill in the art.

The downforce control system 118 is disposed to apply lift and/or downforce on the row unit 100, such as disclosed in U.S. Pat. No. 9,408,337, “Agricultural Row Unit Apparatus, Systems and Methods,” granted Aug. 9, 2016.

The seed-trench opening assembly 120 includes a pair of opening discs 122 rotatably supported by a downwardly extending shank 124 of the frame 110. The opening discs 122 are arranged to diverge outwardly and rearwardly so as to open a V-shaped seed trench 104 in the soil 102 as the planter traverses the field in a forward direction D.

The seed-delivery device 126 includes a seed meter 128 and a seed tube 130 that together may deliver seeds at a preselected rate to the soil 102. The seed meter 128 may be any commercially available seed meter, such as the fingertype meter or vacuum seed meter, such as the vSet® meter, available from Precision Planting LLC, 23333 Townline Rd, Tremont, Ill. 61568. The seed meter 128 may be configured to orient seeds in a preselected orientation to the seed tube 130 by any selected method, such as that shown and described in U.S. Patent Application Publication 2019/0230846, “Systems, Implements, and Methods for Seed Orientation with Adjustable Singulators During Planting,” published Aug. 1, 2019.

The seed tube 130 is positioned between the opening discs 122 to deliver seed from the seed meter 128 into the opened seed trench 104. The depth of the seed trench 104 is controlled by a pair of gauge wheels 134 positioned adjacent to the opening discs 122. The gauge wheels 134 are rotatably supported by gauge wheel arms 136, which are pivotally secured at one end to the frame 110 about pivot pin 138. A rocker arm 140 is pivotally supported on the frame 110 by a pivot pin 142. Rotation of the rocker arm 140 about the pivot pin 142 sets the depth of the seed trench 104 by limiting the upward travel of the gauge wheel arms 136 (and thus the gauge wheels 134) relative to the opening discs 122. The rocker arm 140 may be adjustably positioned via a linear actuator 144 mounted to the row unit frame 110 and pivotally coupled to an upper end of the rocker arm 140. The linear actuator 144 may be controlled remotely or automatically actuated as disclosed, for example, in U.S. Pat. No. 9,864,094, “System for Soil Moisture Monitoring,” granted Jan. 9, 2018.

A downforce sensor may be configured to generate a signal related to the amount of force imposed by the gauge wheels 134 on the soil 102. In some embodiments, the pivot pin 142 for the rocker arm 140 may comprise the downforce sensor, such as the instrumented pins disclosed in U.S. Pat. No. 8,561,472, “Load Sensing Pin,” granted Oct. 22, 2013.

The seed-trench closing assembly 146 includes a closing wheel arm 148 that pivotally attaches to the row unit frame 110. A pair of offset closing wheels 150 are rotatably attached to the closing wheel arm 148 and are angularly disposed to “close” the seed trench 104 by pushing the walls of the open seed trench back together over the deposited seed 106. An actuator 152 may be pivotally attached at one end to the closing wheel arm 148 and at its other end to the row unit frame 110 to vary the down pressure exerted by the closing wheels 150 depending on soil conditions. The seed-trench closing assembly 146 may be of the type disclosed in U.S. Pat. No. 9,848,524, “Agricultural Seed Trench Closing Systems, Methods, and Apparatus,” granted Dec. 26, 2017.

The packer wheel assembly 154 includes an arm 156 pivotally attached to the row unit frame 110 and extends rearward of the seed-trench closing assembly 146 and in alignment therewith. The arm 156 rotatably supports a packer wheel 158. An actuator 160 is pivotally attached at one end to the arm 156 and at its other end to the row unit frame 110 to vary the amount of downforce exerted by the packer wheel 158 to pack the soil over the seed trench 104.

The row cleaner assembly 162 may be the CleanSweep® system available from Precision Planting LLC, 23333 Townline Rd, Tremont, Ill. 61568. The row cleaner assembly 162 includes an arm 164 pivotally attached to the forward end of the row unit frame 110 and aligned with the seed-trench opening assembly 120. A pair of row cleaner wheels 166 are rotatably attached to the forward end of the arm 164. An actuator 168 is pivotally attached at one end to the arm 164 and at its other end to the row unit frame 110 to adjust the downforce on the arm to vary the aggressiveness of the action of the row cleaner wheels 166 depending on the amount of crop residue and soil conditions.

The row unit 100 may optionally carry other sensors 170. In some embodiments, for exemplary and non-limiting purpose, sensors 170 detect soil conditions before and/or after planting. In some embodiments, again for exemplary and non-limiting purpose, sensors 170 include sensors that monitor seed presence and flow, seed spacing, or other parameters useful to monitoring the proper operation of a seed orientation system.

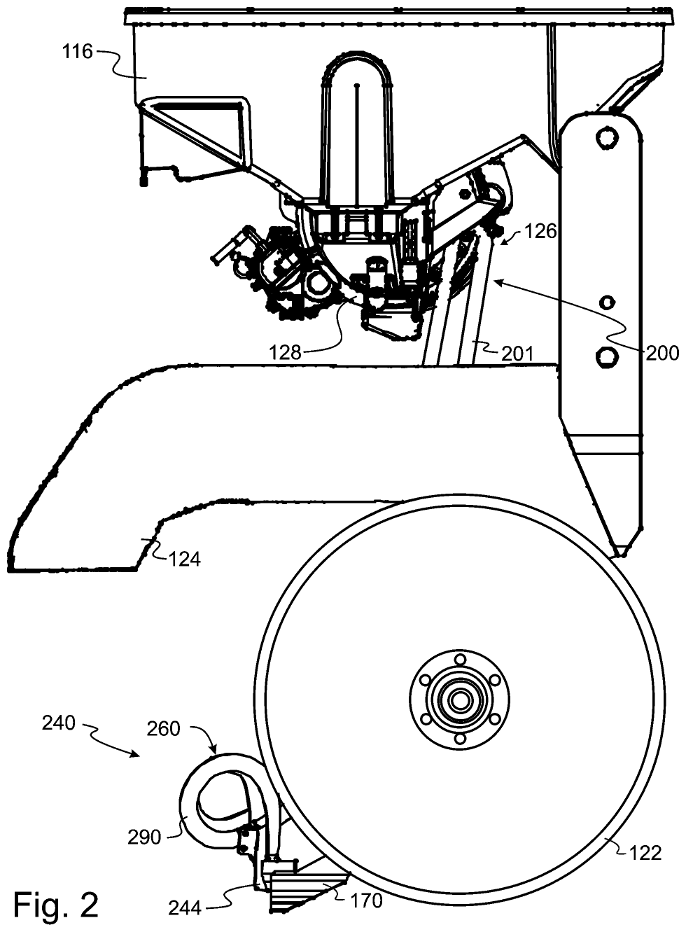

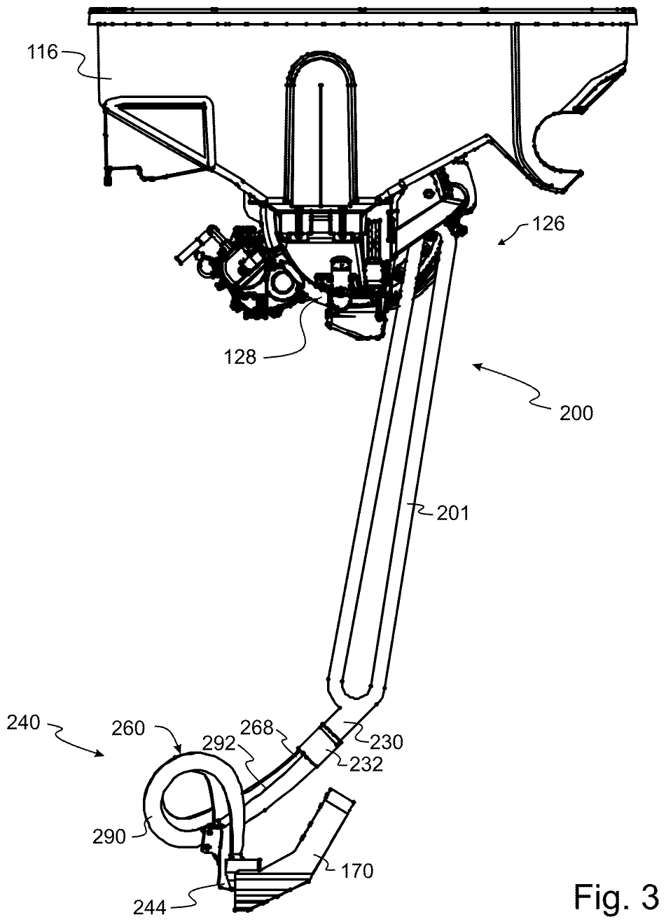

FIGS. 2 and 3 illustrate in further detail one embodiment seed-delivery and orientation apparatus that may be used in the row unit of FIG. 1. As evident from FIG. 2, an exemplary disc 122 is suspended from shank 124 and opens a furrow in the earth just ahead of a subfurrow opener 170. Seed-delivery device 126 includes seed meter 128 and seed conveyor and orientation assembly 200. Seed meter 128 receives seeds 106 from seed hopper 116, singulates seeds 106, and then conveys singulated seeds 106 to seed conveyor and orientation assembly 200. Seed conveyor and orientation assembly 200 preferably delivers oriented seeds 106 from oriented seed exit path 244 into a subfurrow opened by subfurrow opener 170.

As best illustrated in FIG. 3, which provides a view similar to that of FIG. 2 but with the exemplary disc 122 and shank 124 removed for purposes of illustration, conveyor belt 201 delivers seed 106 from seed meter 128 to seed orientation coil assembly 240. Seed 106 arriving from conveyor belt 201 will most preferably slide along a surface within seed conveyor exit 230, most preferably free from bounce, tumbling, or other the like. Seed 106 passes from seed conveyor exit 230 into an optional seed collector 232, which provides a suitable coupling between conveyor belt 201 and seed orientation coil assembly 240.

In the region adjacent to seed collector 232, seed riding surface 292 is fully enclosed and unvented. However, shortly thereafter and continuing as the seed traverses helical pathway 290, the helical pathway is provided with an open side that acts as a vent 268. This surface may be entirely open as illustrated in FIGS. 2 and 3. In alternative embodiments the surface is covered by an air-permeable surface that may for exemplary and non-limiting purpose comprise holes drilled with a laser, drill bit, chemical milling, or any other suitable technique. In yet other alternative embodiments, vent 68 is fabricated from a porous, micro-porous, or otherwise gas-permeable material which provides venting throughout the exterior wall, including for exemplary and non-limiting purpose: a porous material including but not limited to a mesh or screen; sintered metals; porous carbon; porous carbon-graphite; porous carbon-silicates; open-cell foams of any suitable composition; and other breathable materials and compositions. In some alternative embodiments, venting will be provided only selectively at strategic locations, or in other alternative embodiments entirely along seed riding surface 292.

Vented outer coil 260 may comprise any number of degrees of rotation, though as illustrated comprises approximately a single 360 degree rotation. The relatively small diameter helps to increase the centrifugal force generated therein. After passing through vented outer coil 260, seed will then pass into and through oriented seed exit path 244. The operation of this type of seed orienter is further described in U.S. Patent Publication No. US2022/0192079A1, entitled “Aerodynamic and Centrifugal Seed Orientation System for Agricultural Planters,” published Jun. 23, 2022.

In some embodiments, seed collector 232 will incorporate an air infeed into seed orientation coil assembly 240, such as taught by U.S. Patent Publication No. US2022/0192079A1. In such embodiments, the air infeed will preferably drive air through an air injector nozzle into helical pathway 290. In the region adjacent to the air infeed, such as within seed collector 232, helical pathway 290 is preferably fully enclosed and unvented. However, shortly thereafter vented outer coil 260 is provided with an open interior vent 268, which may be entirely open as illustrated, or which in alternative embodiments is covered by an air-permeable surface.

In some alternative embodiments, an air infeed is positioned farther along helical pathway 290, intermediate between seed collector 232 and the aft end of oriented seed exit path 244, such as illustrated by injector core 58 described in U.S. Patent Publication No. 2020/0367425A1. In such embodiments, seed entering into seed orientation coil assembly 240 will most preferably be delivered with appropriate velocity to traverse seed riding path 292 and, where provided, gently engage with a seed guide wall.

Conveyor belt 201 is, in most embodiments, configured to accelerate seeds 106 so that when the seeds are released from seed conveyor exit 230 into seed collector 232 and seed riding path 292, they have enough energy for seed orientation coil assembly 240 to orient the seeds and enough momentum to carry them to the ground. Conveyor belt 201 is, in most embodiments, further configured to retain uniform seed spacing by eliminating timing errors due to dynamic effects of the row unit.

While the inclusion of seed orientation coil assembly 240 can be used in some embodiments, in some alternative embodiments no seed orientation apparatus other than conveyor belt 201 is provided. In alternative embodiments, seed conveyor and orientation assembly 200 is configured to orient seeds in a preselected orientation by other suitable seed orientation apparatus, such alternatives as shown and described in U.S. Patent Application Publications 2020/0367425, entitled “Seed Orientation System for Agricultural Planters” and published Nov. 26, 2020, and 2022/0192079, entitled “Aerodynamic and Centrifugal Seed Orientation System for Agricultural Planters” and published Jun. 23, 2022, and as also described herein below.

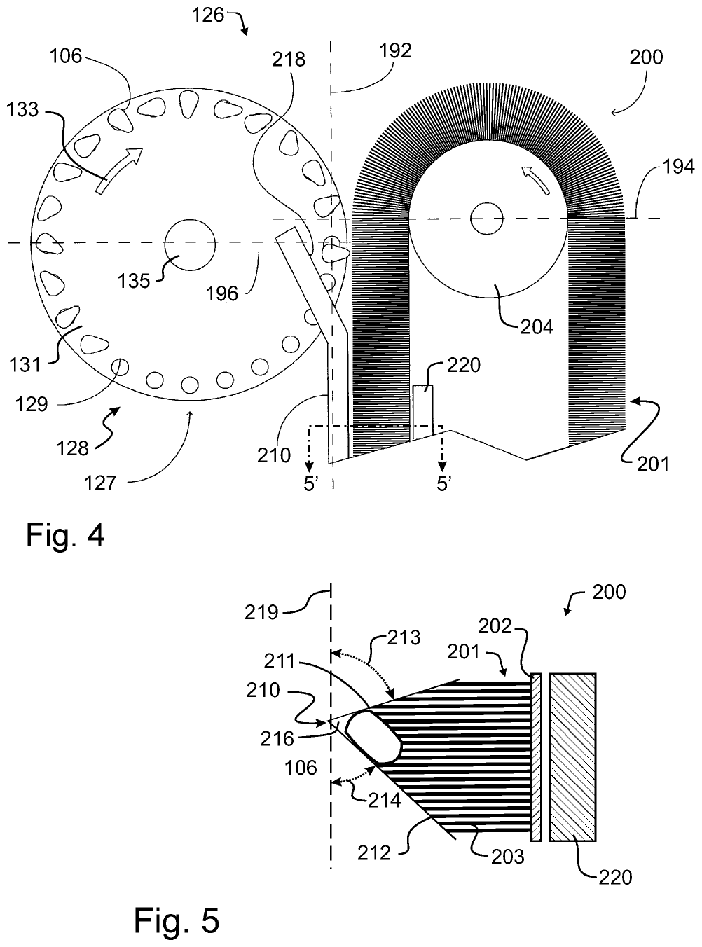

In other alternative embodiments, seed meter 128 is configured to orient seeds before or as they are delivered to seed conveyor and orientation assembly 200. For example, seed meter 128 may include a vision system and a singulator with features (e.g., lobes) configured to orient seeds, such as shown in FIGS. 4A-4C of U.S. Patent Application Publication 2019/0230846, “Systems, Implements, and Methods for Seed Orientation with Adjustable Singulators During Planting,” published Aug. 1, 2019. In yet other alternative embodiments other types of seed orientation systems will be used, including but not solely limited to those described in the background section herein above.

Seed-delivery device 126 is illustrated in simplified form in FIG. 4, including both seed meter 128 and seed conveyor and orientation assembly 200. Seed-delivery device 126 receives seeds 106 from seed hopper 116, singulates seeds 106 in seed meter 128, and then conveys singulated seeds 106 from seed meter 128 to seed conveyor exit 230.

In one embodiment, seed meter 128 has a seed disc 131 (metering unit) that rotates in a direction indicated by arrow 133 about a shaft 135 rotatably mounted in the seed meter. Seed meter 128 is preferably of the vacuum type as is known in the art, such that a vacuum source (not shown) creates a vacuum behind seed disc 131 (on the perspective of FIG. 4), thus creating a pressure differential across apertures 129 in the disc. As the apertures 129 rotate past a pool of seeds in the location generally indicated by reference numeral 127, the pressure differential causes an individual seed 106 to become entrained on each aperture 129 such that the seeds are carried by the disc as illustrated. The size and spacing of the holes may vary based on the type of seed to be planted. As the apertures cross a boundary such as axis 196, preferably at approximately the 3 o'clock position of the seed disc 131, the vacuum source is substantially cut off (e.g., by termination of a vacuum seal as is known in the art) such that the seeds 106 are released from the disc as they cross axis 196. In one embodiment, seeds 106 fall from the disc in a substantially vertical fashion along an axis 192 and drop into seed conveyor and orientation assembly 200 properly singulated and timed. In another embodiment, seeds 106 can be entrained directly into brush bristles or flights 206 as described in U.S. Pat. Nos. U.S. Pat. No. 8,813,663B2, U.S. Pat. No. 8,850,998B2, U.S. Pat. No. 9,480,199B2, U.S. Pat. No. 9,510,502B2, U.S. Pat. No. 9,661,799B2, U.S. Pat. No. 9,686,906B2, U.S. Pat. No. 9,699,955B2, U.S. Pat. No. 9,807,922B2, U.S. Pat. No. 9,807,924B2, U.S. Pat. No. 9,820,429B2, U.S. Pat. No. 9,861,031B2, and U.S. Pat. No. 10,004,173B2. In another embodiments, the metering unit can be metering member 100 as described in U.S. Pat. No. 8,850,998B2.

Seeds 106 may in some embodiments arrive at seed conveyor and orientation assembly 200 with inertia and momentum that might not align with and follow the subsequent seed path, for exemplary and non-limiting purpose tumbling and/or bouncing. Allowing a seed 106 to tumble, bounce, or otherwise take an indirect path through seed conveyor and orientation assembly 200 can lead to substantial variation in time required to traverse from seed meter 128 into the earth. Said another way, a seed 106 which follows a curved seed path between two points will require more travel time than a seed 106 traveling at the same speed but that bounces off the seed path and thereby travels in a straight line between the same two points. This results in inconsistent seed spacing that can lead to undesirable crowding of seeds and commensurate greater-than-desired gaps. To limit the impact of this unpredictable seed path timing, slower planting speeds that are more tolerant of the timing variances has heretofore been required.

In accord with the teachings of the present invention, seed conveyor and orientation assembly 200 is provided to stabilize and constrain these individual and sequential seeds 106 to slide upon seed riding surface 292. For the purpose of the present disclosure, a seed constrained to sliding upon seed riding surface 292 will be substantially free of tumbling or bouncing, and will instead slide along seed riding surface 292 in substantially continuous contact therewith. When seed 106 is so constrained, there will be a force generated by the friction of the seed sliding over the surface, or an equivalent thereto, that is in a direction generally opposite to the direction of travel of the seed along the seed path.

Seed conveyor and orientation assembly 200 includes a conveyor belt 201 stretched around an upper and a lower pulley. Examples of this belt arrangement are described in FIGS. 2A-2C and the associated text in PCT Publication WO2013/049198, and are available in the SpeedTube™ system from Precision Planting LLC of Tremont, Illinois. Drive apparatus 204 may for exemplary and non-limiting purpose comprise a rotary drive motor and pulley on a first end, and an idler pulley distal thereto. In other embodiments the seed conveyor and orientation assembly 200 will be driven by the lower pulley and in yet other embodiments with different motor types and constructions. Nearly all modern agricultural row planting equipment is equipped with one or more of a suitable source of electricity, pressurized air, hydraulic fluid, and motive power. In consideration thereof, for exemplary and non-limiting purpose drive apparatus 204 may derive power from one of these sources and so comprise an electric motor, a pneumatic drive, a hydraulic drive, a friction wheel, a gear drive, or the like. In most embodiments, conveyor belt 201 and seed meter 128 are preferably driven at a speed proportional to or otherwise related to and dependent upon the ground speed of row unit 100, in order to provide a consistent seed spacing reasonably independent of ground speed of agricultural planter row unit 100.

Conveyor belt 201 as illustrated has an endless central belt 202 and a plurality of brush bristles 203 (e.g., impellers) securely affixed with and protruding outward from central belt 202. Nevertheless, in some alternative embodiments other impellers are used instead of brush bristles 203, for exemplary and non-limiting purpose such as flights disclosed in the aforementioned PCT Publication WO2013/049198 or a resilient or elastomeric material such as a foam rubber or clastic sheet of suitable geometry.

Seed conveyor and orientation assembly 200 additionally includes a guide surface 210 on one side of the seed conveyor, disposed adjacent to brush bristles or flights 203. Guide 210 includes an angled seed collector 218, along which each seed 106 slides downward when released from seed disc 131, where it will become captured between guide 210 and brush bristles or flights 203.

As illustrated, the spacing of endless belt 202 from guide 210 is selected so that a seed 106 traversing guide 210 will be pressed into and held against guide 210 in a non-damaging manner, and will not be allowed to slip between brush bristles or flights 203 or the equivalent and guide 210 without simultaneously contacting both. In this embodiment, this spacing is fixed, thereby simplifying the construction and operation of this seed conveyor and orientation assembly 200. In some alternative embodiments, this spacing is adjustable to allow an operator to adjust the apparatus to constrain different types, geometries, or dimensions of seed. In further alternative embodiments, a spring is provided to resiliently hold endless belt 202 against guide 210. In yet further alternative embodiments, a sensor and automatically adjustable drive, for exemplary and non-limiting purposes such as a screw drive, are provided to automatically apply an appropriate force pressing endless belt 202 against guide 210.

In some alternative embodiments, a small amount of agitation may be desired within guide 210. In such embodiments, bumps or other surface irregularities may be provided that agitate seed 106 passing in contact therewith.

When the length and geometry of conveyor belt 201 permits, in some embodiments the spacing of endless belt 202 from guide 210 can be set to disable contact therebetween, either manually or with automatic spacing control. In the event of a manually or automatically detected failure within seed conveyor and orientation assembly 200, such as a failure of endless belt 202 to move or rotate, separating endless belt 202 from guide 210 to allow seeds 106 to pass therebetween will allow seeds to still pass through seed conveyor and orientation assembly 200 and be planted in the earth.

In addition to proper spacing, the stiffness and fill density of brush bristles 203 is selected to prevent individual seeds from slipping between adjacent brush bristles and thereby potentially losing contact with guide 210. In those alternative embodiments that incorporate a resilient or elastomeric material such as a foam rubber or clastic sheet, the density or elasticity of the foam rubber or clastic sheet in the aforementioned alternative embodiments will similarly be selected to ensure that individual seeds 106 simultaneously contact both endless belt 202 and guide 210. This combination provides instantaneous contact and stabilization between the seed and guide 210.

In some alternative embodiments using flights such as disclosed in FIGS. 2C 5A, 5D, and 10B of the aforementioned PCT Publication WO2013/049198, seed 106 undergoes acceleration that includes the application of centrifugal force adjacent the end of guide 210 prior to release of seed 106 therefrom. In such embodiments, with an appropriate “V”-shaped geometry of guide 210 such as taught and illustrated herein, seed 106 may further undergo seed orientation.

While seed acceleration including centrifugal force is shown adjacent the seed exit in the aforementioned PCT Publication WO2013/049198, in yet further alternative embodiments other locations within conveyor belt 201 will be designed to provide this application of centrifugal force in combination with suitable geometry of guide 210. Conveyor belt 201 may be configured to include changes of conveyor direction at one or more locations along guide 210 intermediate between seed meter 128 and seed conveyor exit 230. For exemplary and non-limiting purpose, in some embodiments this is simply a continuously curved geometry in at least the seed transporting portion that more nearly resembles the outline of a circle, rather than that of the numeral “0” illustrated in FIG. 3.

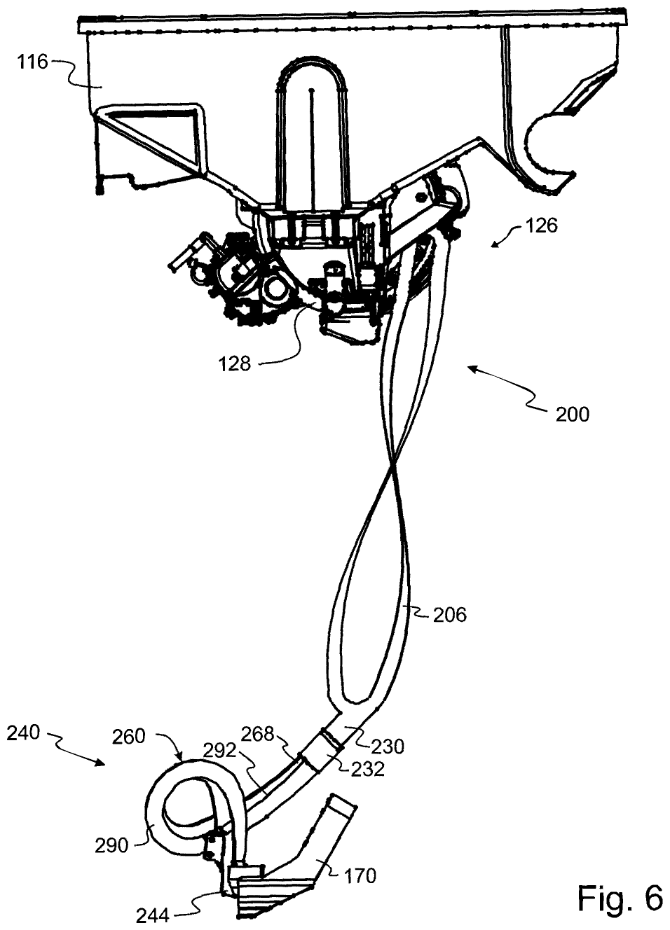

FIG. 6 illustrates another alternative embodiment, where conveyor belt 201 which is in the general shape of the numeral “0” has been replaced by a twisted conveyor belt 206. As may be garnered from the illustration of twisted conveyor belt 206, this belt has been twisted in the general manner of a pretzel, converting conveyor belt 201 to twisted conveyor belt 206 by providing an approximate 180 degree twist between the top and bottom of the conveyor belt. The particular degree of twist may vary widely from and be greater or less than the approximate 180 degree twist shown, the extent which will be determined by a reasonably skilled designer upon a review of the present disclosure and consideration of the desired centrifugal force and other related factors. This twist means that a seed traversing twisted conveyor belt 206 from seed meter 128 to seed conveyor exit 230 will travel a helical path, essentially continuously undergoing the application of centrifugal force. In some embodiments, sliding surface 212 is additionally banked, such as in the manner described in U.S. Patent Application Publications 2020/0367425 and 2022/0192079.

In consideration thereof, and whether curved, twisted, or simply sufficiently curved adjacent seed conveyor exit 230, conveyor belt 201 may provide a desired degree of orientation within seed conveyor and orientation assembly 200 independent of seed orientation coil assembly 240. Consequently, in some of these alternative embodiments a designer will elect to eliminate seed orientation coil assembly 240. In other embodiments, a conveyor belt 201, 206 which provides seed orientation benefit will be further enhanced by the inclusion of seed orientation coil assembly 240. Such consideration and decisions will be made by a designer reasonably skilled in the art upon consideration of the teachings of the present disclosure.

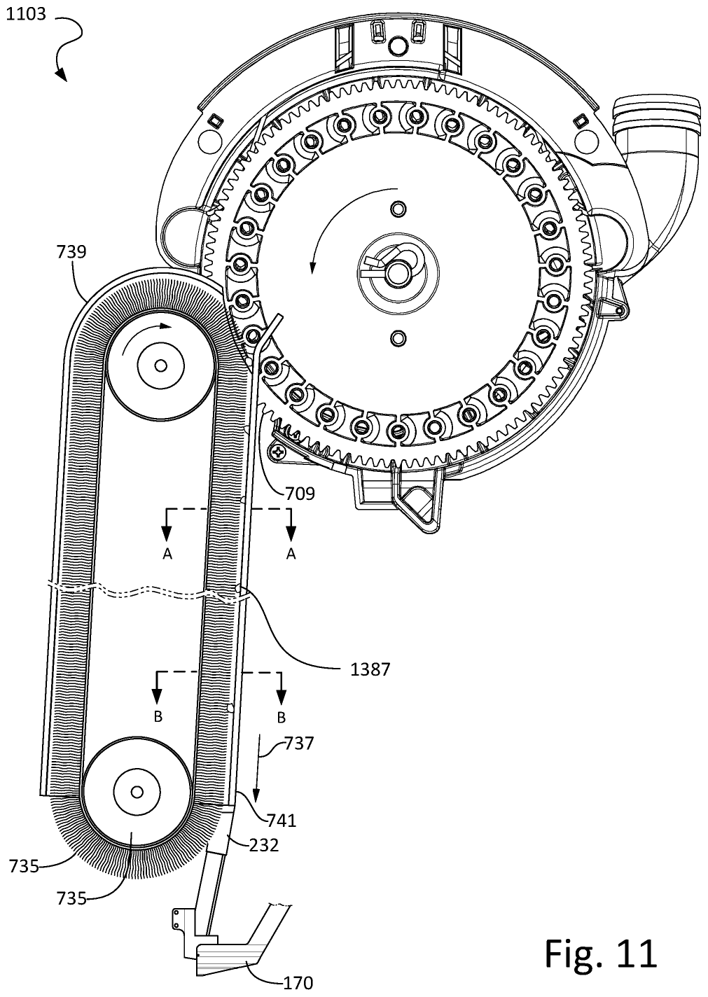

As illustrated in FIG. 4, drive apparatus 204 and seed disc 131 rotate in opposite directions, clockwise and counterclockwise respectively. However, in alternative embodiments the position of seed conveyor and orientation assembly 200 may be flipped relative to seed disc 131, and in such embodiments the rotations of drive apparatus 204 and seed disc 131 may be in the same direction, such as clockwise. An example of such an arrangement and direction of rotation, further including flights instead of brush bristles 203, is shown in FIGS. 11A-11E of the aforementioned PCT Publication WO2013/049198 and described therein.

In one embodiment, the simplified cross-sectional view of FIG. 5 is taken on a horizontal plane. As illustrated therein, vertical plane 219 contains vertical seed drop axis 192 and is generally parallel with and offset from a vertical plane defined by a major surface of endless belt 202. Guide surface 210 has two surfaces, a guide wall 211 and sliding surface 212, that together form a “V”-shaped channel that opens toward endless central belt 202. Brush bristles or flights 203 track in this channel opening of guide surface 210. The guide wall angle 213 between vertical plane 219 and guide wall 211 is preferably greater than the sliding surface angle 214 between vertical plane 219 and sliding surface 212. In some embodiments, sliding surface angle 214 is 0 to 60 degrees, or 0 to 45 degrees, or about 45 degrees. Guide wall angle 213 is the supplementary angle to sliding surface angle 214 and an angle formed by small open space 216 such that all three angles form a straight line. As illustrated, seed 106 will in some embodiments align or be aligned through appropriate technique such that a major surface of seed 106 will slide upon sliding surface 212, while a minor surface of seed 106 will slide upon guide wall 211. A seed 106 traversing guide surface 210 is pressed into the intersection between guide wall 211 and sliding surface 212 by brush bristles or flights 203, leaving a small open space 216 between seed 106 and the base of the “V”-shaped channel opening, adjacent the intersection between guide wall 211 and sliding surface 212. Small open space 216 forms an angle of 80 to 95 degrees, or about 90 degrees, or an acute angle. While as illustrated and described FIG. 5 is taken on a horizontal plane, it will be understood that the travel of endless central belt 202 will in some embodiments and through parts of travel will run in a direction offset from a vertical path of travel. In such instance, a section view similar to FIG. 5 would also be offset from vertical, as would vertical plane 219. Consequently, it will be understood that the references herein to vertical and horizontal are only exemplary and as illustrated in FIGS. 4 and 5, and do not limit the invention solely thereto. In one embodiment, sliding surface angle is 45 degrees, guide wall angle is 45 degrees, and the angle formed by small open space 216 is 90 degrees.

The bristles or flights 203 in the embodiment as illustrated in FIGS. 4 and 5 do not extend all the way to the intersection between guide wall 211 and sliding surface 212, leaving this open space 216 open and unblocked through most or the entirety of guide surface 210. Nevertheless, in some alternative embodiments the bristles or flights 203 will extend all the way to the intersection between guide wall 211 and sliding surface 212.

When the bristles or flights 203 do not extend all the way to the intersection between guide wall 211 and sliding surface 212, air may naturally be drawn into open space 216 by virtue of the travel of conveyor belt 201 and seeds 106 transported therein. This air stream will in some embodiments provide assistance to seed orientation and travel into the earth. Nevertheless, in some alternative embodiments the air flow may be enhanced through the provision of air vents provided at suitable locations within guide 210 or otherwise adjacent to open space 216 to improve a transfer of air into the seed pathway. In other alternative embodiments, air may be injected into open space 216 or bristles or flights 203 at one or more suitable locations. When air is so injected, and if properly directed, this airfeed may serve as the air infeed into seed orientation coil assembly 240, such as taught by U.S. Patent Publication No. US2022/0192079A1. However air is introduced into and moved through open space 216, such air may in some embodiments also assist with the transport of undersized seeds, debris, and other matter from conveyor belt 201.

Most preferably, seed sliding surface 212 couples in a continuous and non-disruptive manner to seed riding surface 292. In like manner, guide wall 211 will in some embodiments couple in a continuous and non-disruptive manner to a similar guide wall adjacent to seed riding surface 292. This helps to insure that seed 106 passes from conveyor belt 201 into seed orientation coil assembly 240 in sliding contact with seed riding surface, most preferably free from bounce, tumbling, or the like.

The seed conveyor and orientation assembly 200 preferably also includes a backing plate 220 disposed to maintain the position of central belt 202 relative to guide surface 210. While not illustrated in simplified FIGS. 4 and 5, it will be understood that in many embodiments conveyor belt 201 will further include a housing surrounding and enclosing central belt 202 and bristles or flights 203.

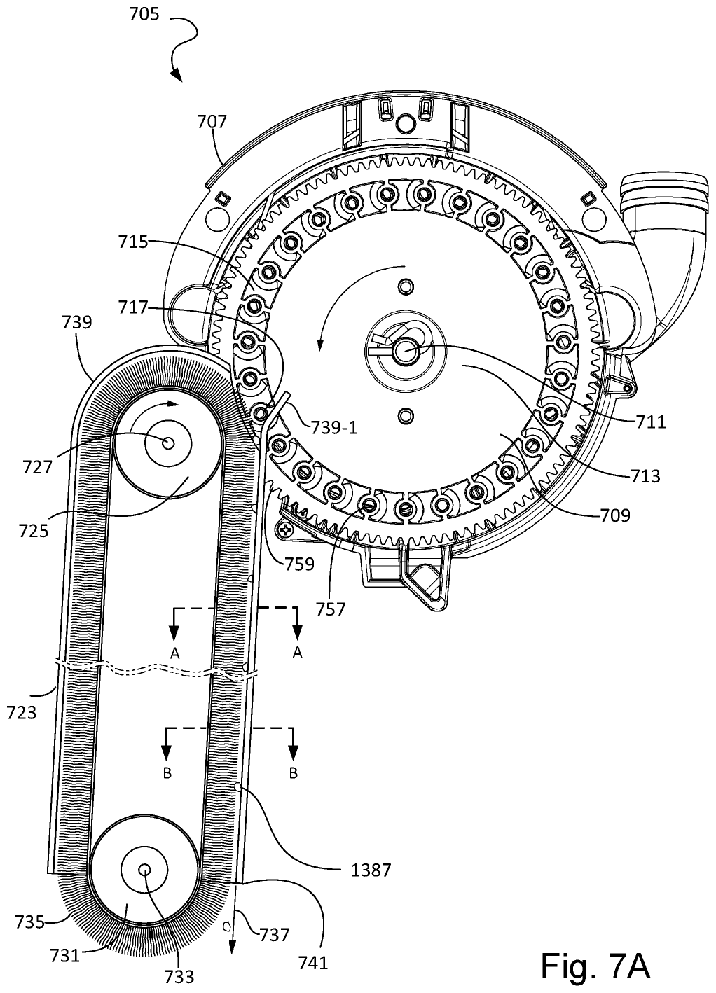

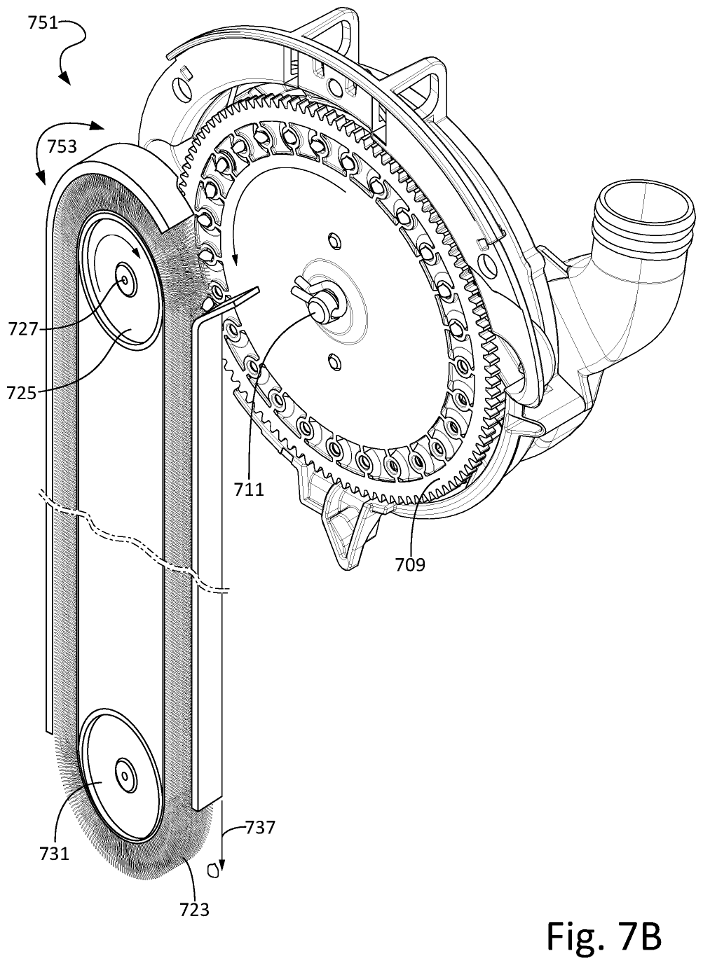

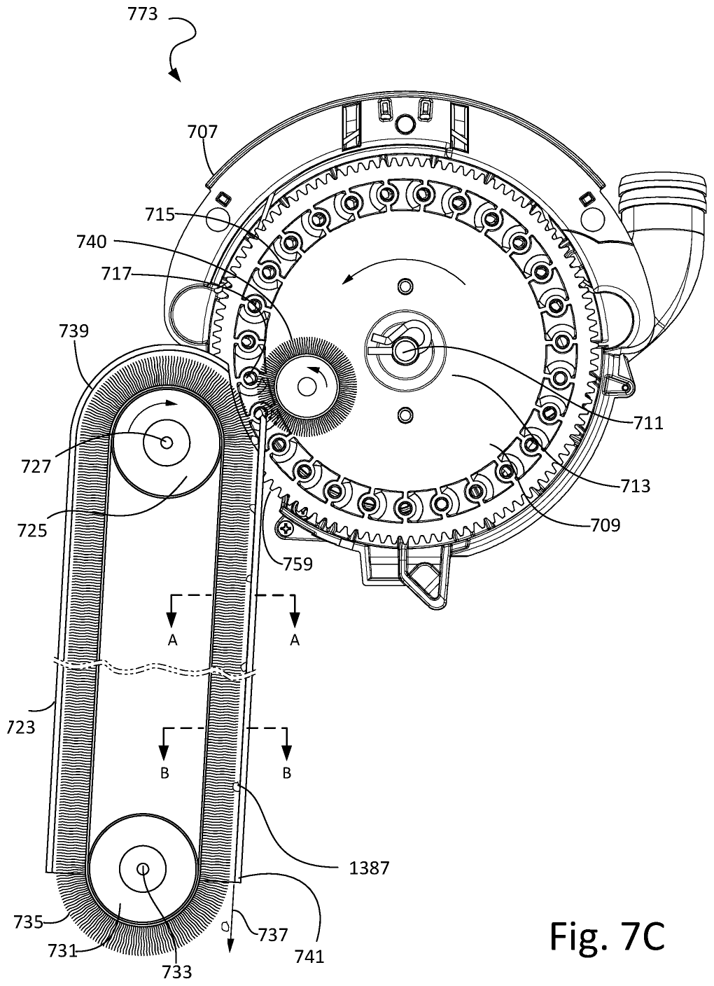

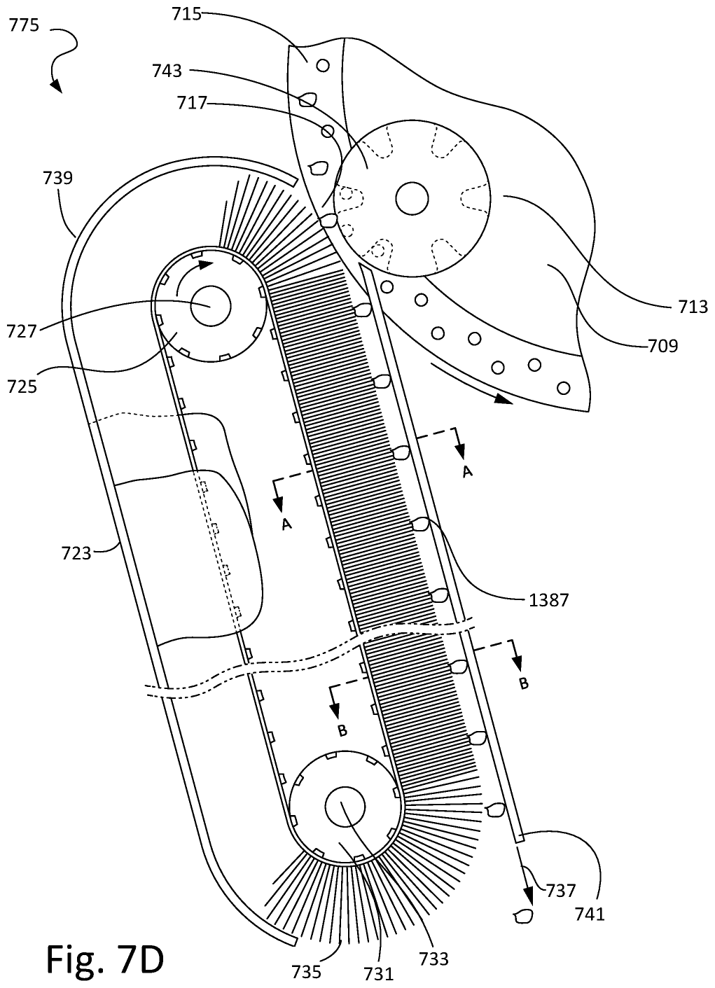

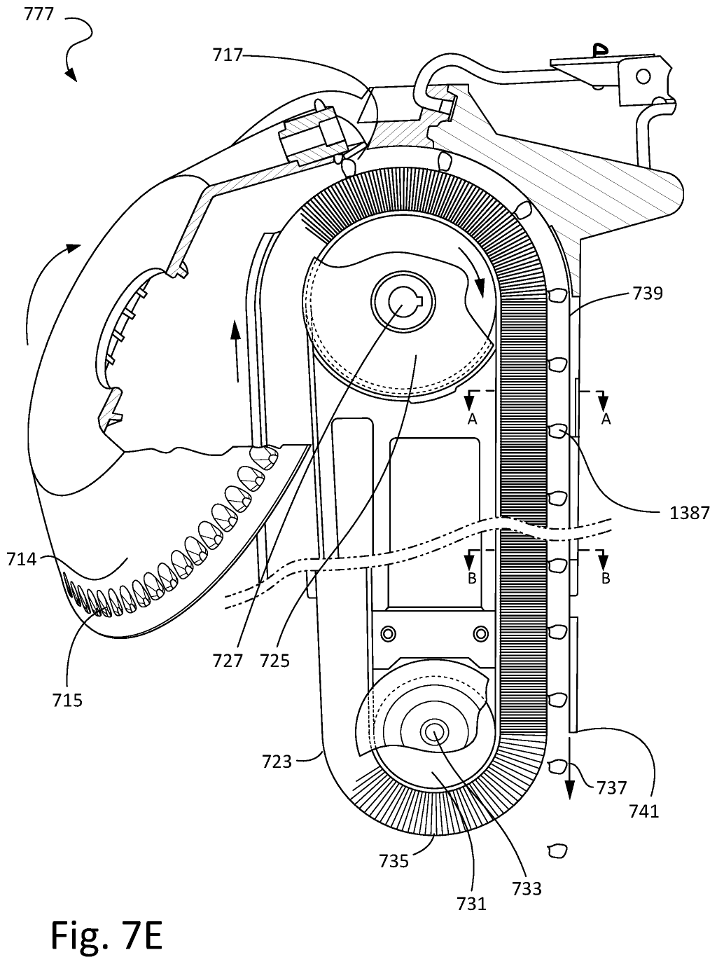

FIG. 7A illustrates an example of a seed metering and delivery apparatus 705. The apparatus 705 may comprise a seed meter 707. The seed meter 707 may comprise a seed meter disc 709 that may be rotatable about a seed meter disc axis 711. The seed meter disc 709 may comprise at least a front face 713 that may be configured to move one or more seeds 1387 at a seed meter disc speed along a seed supply path 715 to a removal location 717.

A delivery system 723 may comprise a first seed belt wheel 725 that may be rotatable about a first seed belt wheel axis 727. The first seed belt wheel 725 may be disposed proximate (e.g., within 6-36 inches, or the like) to the seed meter disc 709. The delivery system 723 may comprise a second seed belt wheel 731 that may be rotatable about a second seed belt wheel axis 733. The second seed belt wheel 731 may be distally disposed (e.g., from 0.3 to 6 feet, or the like) from the first seed belt wheel 725.

The delivery system 723 may comprise a seed belt 735. The seed belt 735 may be configured to traverse at least a portion of a seed delivery path 737 around the first seed belt wheel 725 and/or the second seed belt wheel 731. The seed belt 735 may have at least an active surface (not shown) which may support the one or more seeds 1387 and a wheel surface (not shown). The first seed belt wheel 725 may be positioned adjacent the front face 713 of the seed meter disc 709 such that at least some of the active surface at least partially crosses the seed supply path 715 at the removal location 717.

The delivery system 723 may comprise a seed belt housing 739. The seed belt housing 739 may be positioned (e.g., discontinuously) to at least partially cover at least a portion of the seed delivery path 737 opposite the active surface of the seed belt 735. The seed belt housing 739 may comprise at least an exterior surface (not shown) and an interior surface (not shown). The interior surface may be arranged opposite the active surface of the seed belt 735 forming a pocket space (not shown) between the active surface of the seed belt 735 and the interior surface. The pocket size may be configured to receive and/or accommodate a change in orientation (not shown) of the one or more seeds 1387. A portion of the seed belt housing 739 may comprise an angled wall 739-1 that may extend over the seed meter disc 709 proximate to the removal location 717 such that the angled wall 739-1 may motivate and/or deflect the one or more seeds 1387 off of the seed meter disc 709 and into the seed delivery path 737.

The seed belt 735 may be configured to receive the one or more seeds 1387 from the front face 713 of the seed meter disc 709 which are carried along the active surface at a seed belt speed (e.g., without intermingling with seed belt projections, if any). The seed belt 735 may be configured to convey the one or more seeds 1387 along at least a portion of the seed delivery path 737 to a delivery discharge location 741 proximate (e.g., from 0.3 to 6 feet, or the like) to the second seed belt wheel 731.

In one or more scenarios, the seed meter disc 709 may rotate in a seed meter disc plane of movement (not shown). The first seed belt wheel 727 may rotate in a first seed belt wheel plane of movement (not shown). The apparatus 705 may be configured such that the seed meter disc plane of movement and the first seed belt wheel plane of movement may be substantially (e.g., within a few degrees, or the like) parallel to each other and/or non-intersecting with each other, for example.

In one or more scenarios, the seed meter disc axis 711 and the first seed belt wheel axis 727 may be substantially (e.g., within a few degrees, or the like) parallel to each other and/or non-intersecting with each other, for example.

FIG. 7B illustrates an example an example of a seed metering and delivery apparatus 751. The apparatus 751 illustrates the one or more scenarios in which the delivery system 723 and/or the seed delivery path 737 may be orientated relative to the seed meter disc 709 is a non-planar/non-parallel arrangement (e.g., as indicated by arrangement range arrow 753), perhaps for example extending to an orthogonal arrangement (not shown).

Referring to FIG. 7A and FIG. 7B, in one or more scenarios, the seed meter disc 709 may rotate in a seed meter disc plane of movement (not shown). The first seed belt wheel 725 may rotate in a first seed belt wheel plane of movement (not shown). The apparatus 751 may be configured such that the seed meter disc plane of movement and the first seed belt wheel plane of movement may be substantially (e.g., within a few degrees, or the like) non-parallel to each other and/or intersecting with each other.

In one or more scenarios, the seed meter disc axis 711 and the first seed belt wheel axis 727 may be substantially (e.g., within a few degrees, or the like) non-parallel to each other and/or intersecting with each other.

FIG. 7C illustrates an example of a seed metering and delivery apparatus 773. The apparatus 773 may comprise a seed meter 707. The seed meter 707 may comprise a seed meter disc 709 that may be rotatable about a seed meter disc axis 711. The seed meter disc 709 may comprise at least a front face 713 that may be configured to move one or more seeds 1387 at a seed meter disc speed along a seed supply path 715 to a removal location 717.

A delivery system 723 may comprise a first seed belt wheel 725 that may be rotatable about a first seed belt wheel axis 727. The first seed belt wheel 725 may be disposed proximate (e.g., within 6-36 inches, or the like) to the seed meter disc 709. The delivery system 723 may comprise a second seed belt wheel 731 that may be rotatable about a second seed belt wheel axis 733. The second seed belt wheel 731 may be distally disposed (e.g., from 0.3 to 6 feet, or the like) from the first seed belt wheel 725.

The delivery system 723 may comprise a seed belt 735. The seed belt 735 may be configured to traverse at least a portion of a seed delivery path 737 around the first seed belt wheel 725 and/or the second seed belt wheel 731. The seed belt 735 may have at least an active surface (not shown) which may support the one or more seeds 1387 and a wheel surface (not shown). The first seed belt wheel 725 may be positioned adjacent the front face 713 of the seed meter disc 709 such that at least some of the active surface at least partially crosses the seed supply path 715 at the removal location 717.

The delivery system 723 may comprise a seed belt housing 739. The seed belt housing 739 may be positioned (e.g., discontinuously) to at least partially cover at least a portion of the seed delivery path 737 opposite the active surface of the seed belt 735. The seed belt housing 739 may comprise at least an exterior surface (not shown) and an interior surface (not shown). The interior surface may be arranged opposite the active surface of the seed belt 735 forming a pocket space (not shown) between the active surface of the seed belt 735 and the interior surface. The pocket size may be configured to receive and/or accommodate a change in orientation (not shown) of the one or more seeds 1387. A rotatable seed removal wheel 740 (e.g., brush, with or without bristles, etc.) may be positioned over the seed meter disc 709 proximate to the removal location 717 such that seed removal wheel 740 may motivate and/or deflect the one or more seeds 1387 off of the seed meter disc 709 and into the seed delivery path 737.

The seed belt 735 may be configured to receive the one or more seeds 1387 from the front face 713 of the seed meter disc 709 which are carried along the active surface at a seed belt speed (e.g., without intermingling with seed belt projections, if any). The seed belt 735 may be configured to convey the one or more seeds 1387 along at least a portion of the seed delivery path 737 to a delivery discharge location 741 proximate (e.g., from 0.3 to 6 feet, or the like) to the second seed belt wheel 731.

FIG. 7D illustrates an example of a seed metering and delivery apparatus 775. A seed meter disc 709 may be rotatable about a seed meter disc axis (not shown). The seed meter disc 709 may comprise at least a front face 713 that may be configured to move one or more seeds 1387 at a seed meter disc speed along a seed supply path 715 to a removal location 717.

A delivery system 723 may comprise a first seed belt wheel 725 that may be rotatable about a first seed belt wheel axis 727. The first seed belt wheel 725 may be disposed proximate (e.g., within 1-36 inches, or the like) to the seed meter disc 709. The delivery system 723 may comprise a second seed belt wheel 731 that may be rotatable about a second seed belt wheel axis 733. The second seed belt wheel 731 may be distally disposed (e.g., from 0.3 to 6 feet, or the like) from the first seed belt wheel 725.

The delivery system 723 may comprise a seed belt 735. The seed belt 735 may be configured to traverse at least a portion of a seed delivery path 737 around the first seed belt wheel 725 and/or the second seed belt wheel 731. The seed belt 735 may have at least an active surface (not shown) which may support the one or more seeds 1387 and a wheel surface (not shown). The first seed belt wheel 725 may be positioned adjacent the front face 713 of the seed meter disc 709 such that at least some of the active surface at least partially crosses the seed supply path 715 at the removal location 717.

The delivery system 723 may comprise a seed belt housing 739. The seed belt housing 739 may be positioned (e.g., discontinuously) to at least partially cover at least a portion of the seed delivery path 737 opposite the active surface of the seed belt 735. The seed belt housing 739 may comprise at least an exterior surface (not shown) and an interior surface (not shown). The interior surface may be arranged opposite the active surface of the seed belt 735 forming a pocket space (not shown) between the active surface of the seed belt 735 and the interior surface. The pocket size may be configured to receive and/or accommodate a change in orientation (not shown) of the one or more seeds 1387. A rotatable seed removal wheel 743 may be positioned over the seed meter disc 709 proximate to the removal location 717 such that seed removal wheel 743 may motivate and/or deflect the one or more seeds 1387 off of the seed meter disc 709 and into the seed delivery path 737.

The seed belt 735 may be configured to receive the one or more seeds 1387 from the front face 713 of the seed meter disc 709 which are carried along the active surface at a seed belt speed (e.g., without intermingling with seed belt projections, if any). The seed belt 735 may be configured to convey the one or more seeds 1387 along at least a portion of the seed delivery path 737 to a delivery discharge location 741 proximate (e.g., from 0.3 to 6 feet, or the like) to the second seed belt wheel 731.

FIG. 7E illustrates an example of a seed metering and delivery apparatus 777, including a cross-section of one or more elements. A seed meter disc 714 may be rotatable about a seed meter disc axis (not shown). The seed meter disc 714 may be configured to move one or more seeds 1387 at a seed meter disc speed along a seed supply path 715 to a removal location 717.

A delivery system 723 may comprise a first seed belt wheel 725 that may be rotatable about a first seed belt wheel axis 727. The first seed belt wheel 725 may be disposed proximate (e.g., within 6-36 inches, or the like) to the seed meter disc 709. The delivery system 723 may comprise a second seed belt wheel 731 that may be rotatable about a second seed belt wheel axis 733. The second seed belt wheel 731 may be distally disposed (e.g., from 0.3 to 6 feet, or the like) from the first seed belt wheel 725.

The delivery system 723 may comprise a seed belt 735. The seed belt 735 may be configured to traverse at least a portion of a seed delivery path 737 around the first seed belt wheel 725 and/or the second seed belt wheel 731. The seed belt 735 may have at least an active surface (not shown) which may support the one or more seeds 1387 and a wheel surface (not shown). The first seed belt wheel 725 may be positioned adjacent the seed meter disc 709 such that at least some of the active surface at least partially crosses the seed supply path 715 at the removal location 717.

The delivery system 723 may comprise a seed belt housing 739. The seed belt housing 739 may be positioned (e.g., discontinuously) to at least partially cover at least a portion of the seed delivery path 737 opposite the active surface of the seed belt 735. The seed belt housing 739 may comprise at least an exterior surface (not shown) and an interior surface (not shown). The interior surface may be arranged opposite the active surface of the seed belt 735 forming a pocket space (not shown) between the active surface of the seed belt 735 and the interior surface. The pocket size may be configured to receive and/or accommodate a change in orientation (not shown) of the one or more seeds 1387.

The seed belt 735 may be configured to receive the one or more seeds 1387 from the seed meter disc 709 which are carried along the active surface at a seed belt speed (e.g., without intermingling with seed belt projections, if any). The seed belt 735 may be configured to convey the one or more seeds 1387 along at least a portion of the seed delivery path 737 to a delivery discharge location 741 proximate (e.g., from 0.3 to 6 feet, or the like) to the second seed belt wheel 731.

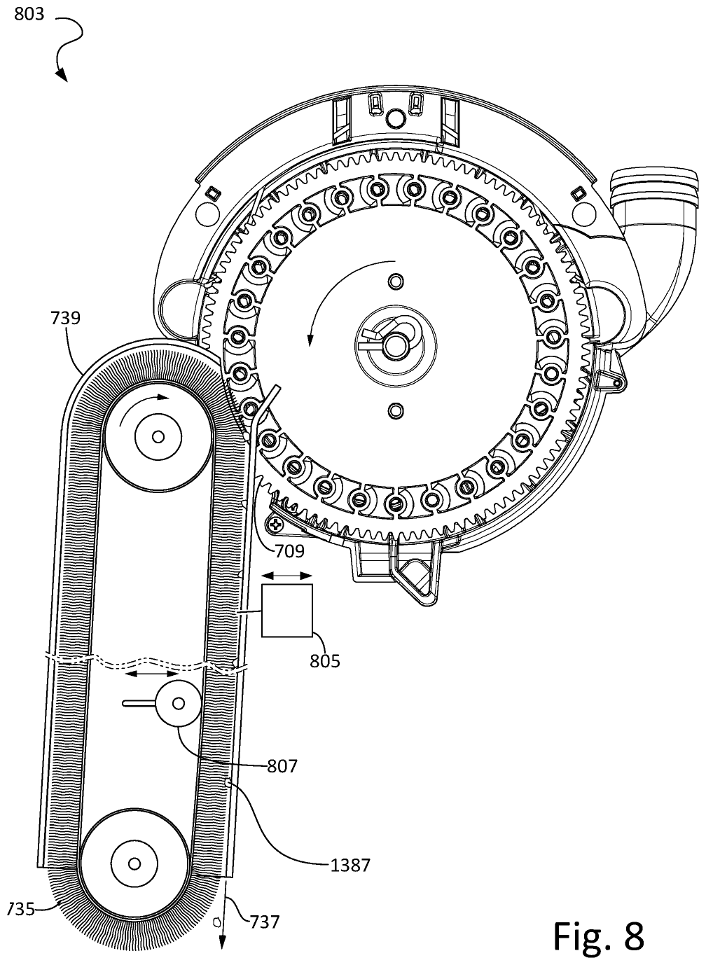

FIG. 8 illustrates an example of a seed metering and delivery apparatus 803 with one or more components that may affect a pocket size in which the one or more seeds 1387 may be conveyed. In one or more scenarios, the apparatus 803 may comprise an actuator and/or springs 805 that may be in mechanical communication with the seed belt housing 739. The actuator 805 may configured to create a variation in a spatial displacement (not shown) of the seed belt housing 739 relative to the seed belt 735. The variation in the spatial displacement may correspond to a variation in the clearance spacing (not shown) between the interior surface (not shown) and the active surface (not shown) of the seed belt 735 along at least a portion of the seed delivery path 737. In one or more scenarios, the actuator 805 may an electric, a pneumatic, and/or a hydraulic device.

In one or more scenarios, the springs 805 may be configured to create a variation in a spatial displacement (not shown) of the seed belt housing 739 relative to the seed belt 735. The variation in the spatial displacement may correspond to a variation in the clearance spacing between the interior surface (not shown) and the active surface (not shown) of the seed belt 735 along at least a portion of the seed delivery path 737.

In one or more scenarios, the apparatus 803 may comprise a tensioner 807 (e.g., a pulley or the like) that may be in mechanical communication with the seed belt 735. The tensioner 807 may be configured to create a variation in tension on the seed belt 735. The variation in the tension may form, at least in part, a variation in a clearance spacing between the interior surface (not shown) and the active surface (not shown) of the seed belt 735 along at least a portion of the seed delivery path 737. The variation in the clearance spacing between the interior surface and the active surface may form, at least in part, the variation in the cross-sectional area of the pocket size (not shown) along at least a portion of the seed delivery path 737.

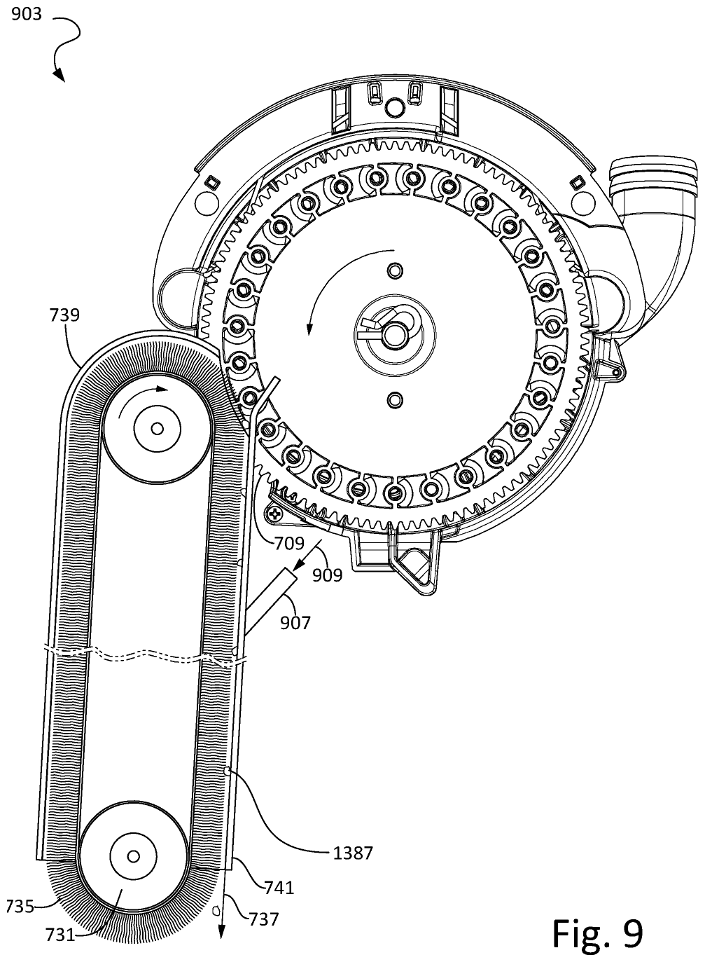

FIG. 9 illustrates an example of a seed metering and delivery apparatus 903 with one or more components that may affect an orientation of the one or more seeds 1387 as the one or more seeds are conveyed along at least a portion of the seed delivery path 737. In one or more scenarios, the seed belt housing 739 may be configured with at least one air port 907. The at least one air port 907 may be configured to convey an air stream 909 to one or more locations along the seed delivery path 737 between the interior surface (not shown) and the active surface (not shown) of the seed belt 735.

In one or more scenarios, the one or more seeds 1387 may have at least a tip-forward orientation. The air stream 909 may impose an air stream force (not shown) on the one or more seeds as the one or more seeds travel along the seed delivery path 737. The air stream force may induce the one or more seeds 1387 into the tip-forward orientation, for example. In one or more scenarios, the apparatus 903 may comprise an air blower (not shown) that may be configured to provide the air stream 909 to at least the seed belt housing 739.

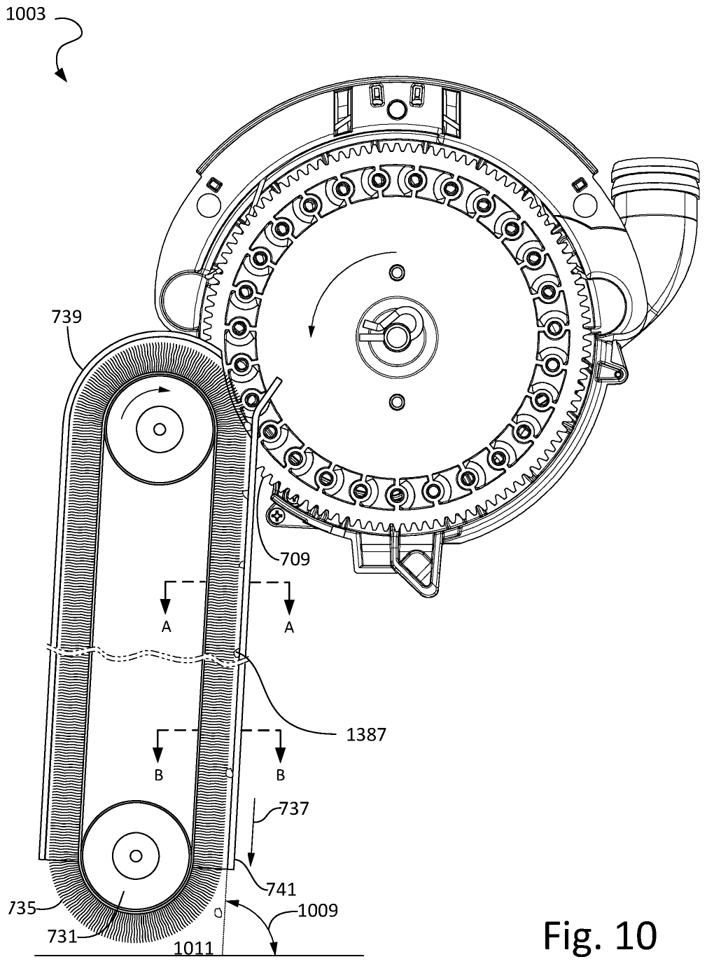

FIG. 10 illustrates an example of a seed metering and delivery apparatus 1003 with a range of delivery discharge location 741 orientations for the one or more seeds 1387 as the one or more seeds 1387 are conveyed along at least a portion of the seed delivery path 737.

In one or more scenarios, the apparatus 1003 may be configured such that the delivery discharge location 741 may be tangential to the second seed belt wheel 731. An orientation of the delivery discharge location 741 may range from, for example, +/−45 degrees (e.g., as indicated at 1009) from a ground reference 1011 upon which the apparatus 1003 may be deployed.

FIG. 11 illustrates an example of a seed metering and delivery apparatus 1103 with a sub-furrow opener/trencher 170 for the deposit of the one or more seeds 1387 into a subfurrow trench (not shown). The apparatus 1103 may comprise a furrow opener 170 that may be configured to open a seed subfurrow (not shown) in an agricultural field (not shown) on which the apparatus 1103 may be deployed. In one or more scenarios, the one or more seeds 1387 may be conveyed by the seed belt 735 to a delivery discharge location 741 and/or to a seed collector 232 (as described herein). The one or more seeds 1387 may be conveyed to the subfurrow (not shown) opened by the subfurrow opener 170.

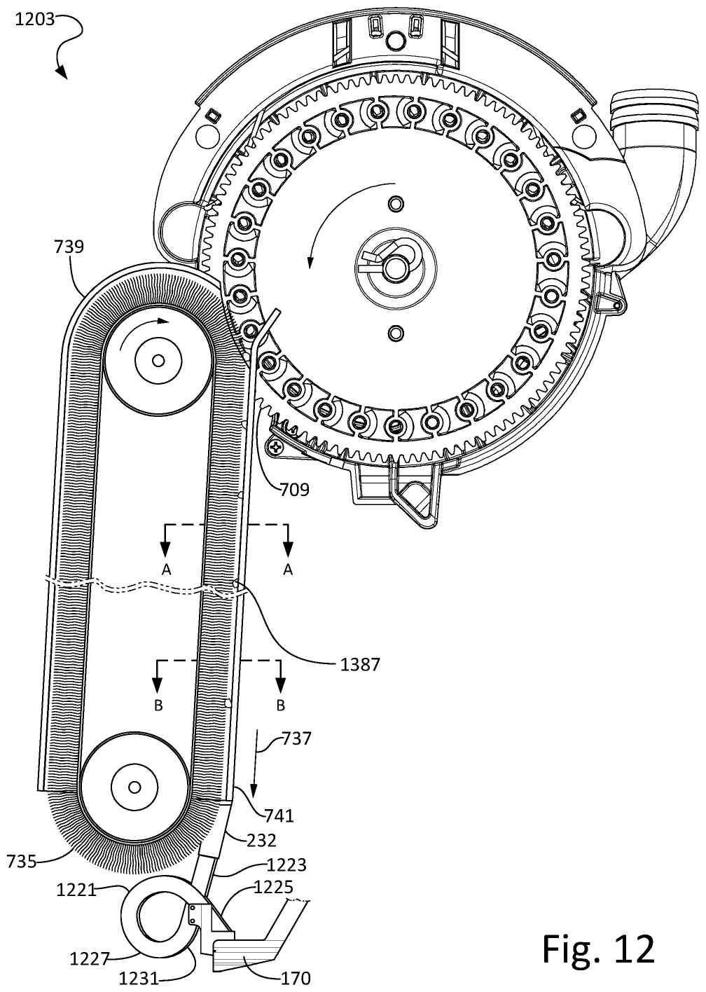

FIG. 12 illustrates an example of a seed metering and delivery apparatus 1203 with a delivery discharge tube 1203 and subfurrow opener/trencher 170 for the deposit of the one or more into a subfurrow/trench (not shown). The apparatus 1203 may comprise a furrow opener 170 that may be configured to open a seed subfurrow (not shown) in an agricultural field (not shown) on which the apparatus 1203 may be deployed. In one or more scenarios, the one or more seeds 1387 may be conveyed by the seed belt 735 to a delivery discharge location 741 and/or to a seed collector 232 (as described herein).

In one or more scenarios, the apparatus 1203 may comprise a dispensing tube 1221 that may be configured to convey the one or more seeds from the delivery discharge location 741 and/or the seed collector 232 to the seed subfurrow opener 170. The dispensing tube 1221 may comprise an upper opening 1223 through which the one or more seeds 1387 may be received from the delivery discharge location 741 and/or the seed collector 232. The dispensing tube 1221 may comprise a lower opening 1225 through which the one or more seeds may be discharged from the dispensing tube 1221 to the subfurrow opener/trencher 170.

In one or more scenarios, the dispensing tube 1221 may comprise a dispensing track 1227 with a continuous curvature 1231 disposed in an inner surface (not shown) of the dispensing tube 1221. The continuous curvature 1231 of the dispensing track 1227 may be configured to induce the one or more seeds into the tip-forward orientation with at least centrifugal force applied as the one or more seeds travel through the continuous curvature 1231 of the dispensing track 1227 to the lower opening 1225.

In one or more scenarios, the dispensing tube 1221 may be substantially (e.g., at least 85%, or the like) hollow and/or free of any internal structures. In one or more scenarios, the continuous curvature 1231 of the dispensing track 1227 may comprise one or more helically shaped sections (not shown). In one or more scenarios, the dispensing tube 1221 may be configured with a substantially curved outer surface.

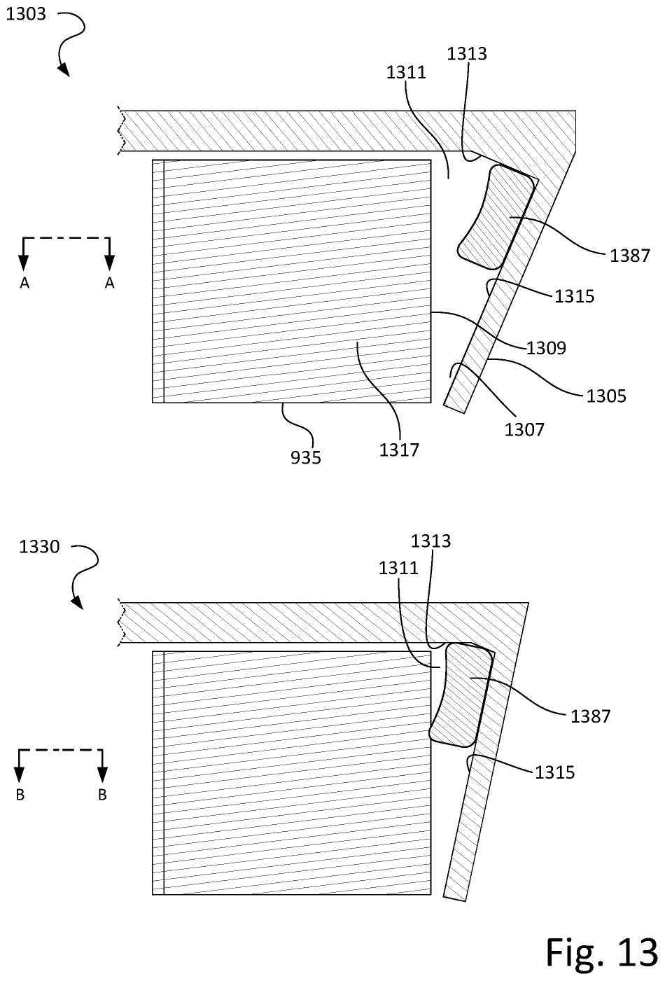

Referring to FIG. 7A to FIG. 12, FIG. 13 illustrates two cross-sectional views 1303 and 1330 of a seed pocket and seed belt 935 at two different locations on the seed delivery path 737. In any of the seed metering and delivery apparatuses described herein, the pocket size has a cross-sectional area. Any of the seed metering and delivery apparatuses described herein may be configured such that a variation in the cross-sectional area may occur along at least a portion of the seed delivery path 737. In FIG. 13 to FIG. 16, the A-A and the B-B cross sectional images refer to example cross sections of any of the A-A section and/or the B-B section shown on FIG. 7A, FIG. 7C, FIG. 7D, FIG. 7E, FIG. 10, FIG. 11, and FIG. 12.

Referring to FIG. 13, the cross section 1303 may comprise an exterior surface 1305 and an interior surface 1307 of a seed belt housing 739. The interior surface 1307 may be arranged opposite an active surface 1309 of the seed belt 935 that may form a pocket space 1311 between the active surface 1309 of the seed belt 935 and the interior surface 1307. The size of the pocket space 1311 (e.g., a pocket size) may be configured to receive and/or accommodate a change in orientation of the one or more seeds 1387.

In one or more scenarios, the interior surface may comprise at least a guide surface 1313 and/or a riding surface 1315. The guide surface 1313 and the riding surface 1315 may be arranged opposite the active surface 1309 of the seed belt 935 that may further define the pocket space 1311. A variation in the cross-sectional area of the seed pocket 1311 may induce, at least in part, a change in orientation (e.g., into the tip-forward orientation) of the one or more seeds 1387 as the one or more seeds travel along at least a portion of the seed delivery path 737.

In one or more scenarios, wherein the seed belt 935 may comprise a projection-less surface 1317 that may define the active surface 1309 which may support the one or more seeds. The projection-less surface 1317 may comprise one or more types of material. The one or more types of material may be one or more of a rubber material, a nylon material, an elastomeric material, a felt material, a fiberous material, and/or a polymer material.

In one or more scenarios, the seed belt housing 739 may be configured for variable positioning relative to the seed belt 935 to create a variation in a clearance spacing between the interior surface 1307 and the active surface 1309 of the seed belt 935 along at least a portion of the seed delivery path 737. The variation in the clearance spacing between the interior surface 1307 and the active surface 1309 may form, at least in part, a variation in the cross-sectional area of the pocket size along at least a portion of the seed delivery path 737. In one or more scenarios, the variation in the cross-sectional area may provide a mechanical manipulation of the one or more seeds 1387 inside the pocket space 1311. In one or more scenarios, the one or more seeds 1387 may have at least a tip-forward orientation (not shown). The mechanical manipulation may induce the one or more seeds 1387 into the tip-forward orientation.

In one or more scenarios, the variation in the cross-sectional area/pocket space 1311 along at least a portion of the seed delivery path 737 may induce the one or more seeds 1387 into the tip-forward orientation.

In one or more scenarios, one or more friction inducing textures and/or one or more friction inducing materials (not shown) may be disposed on the interior surface 1307 of the seed belt housing 739. In one or more scenarios, the one or more seeds 1387 may have at least a tip-forward orientation (not shown). The one or more friction inducing textures and/or the one or more friction inducing materials may impose a moment on the one or more seeds 1387 as they travel along the seed delivery path 737. The moment may induce the one or more seeds 1387 into the tip-forward orientation (not shown).

In one or more scenarios, the variation in the cross-sectional area/pocket size 1311 along at least a portion of the seed delivery path 737 may correspond to a larger cross-sectional area/pocket size 1311 proximate to the first seed belt wheel 725 relative to a smaller cross-sectional area/pocket size 1311 proximate to the second seed belt wheel 731.

In one or more scenarios, an arrangement of the guide surface 1313 and the riding surface 1315 may form a first geometry. The interior surface 1307 may be configured such that a variation in the arrangement of the guide surface 1313 and the riding surface 1313 may occur along at least a portion of the seed delivery path 737. The variation in the arrangement may form a second or more geometries. The second or more geometries may form, at least in part, a second or more cross-sectional areas of the pocket size 1311.

In FIG. 13, cross section 1330 illustrates an example of a different cross section B-B of the pocket space 1311 formed via a different geometry in the arrangement of the guide surface 1313 and the riding surface 1315 at descending point along the seed delivery path 737. In cross section 1330, the one or more seeds 1387 may be motivated into a particular (e.g., desired, tip forward, etc.) orientation in a (e.g., smaller, different) cross-sectional area/pocket size 1311.

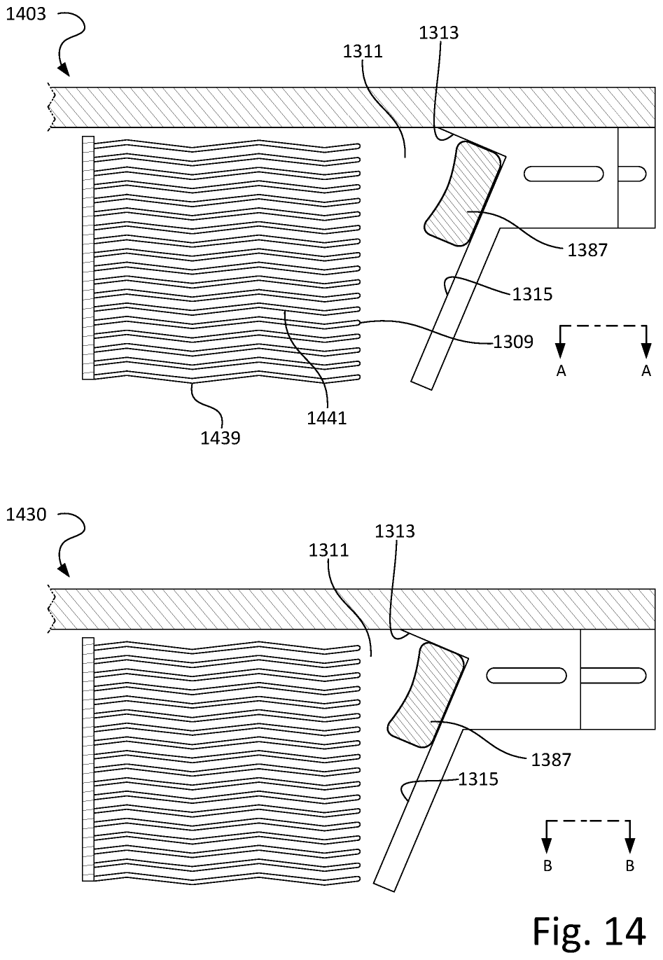

In FIG. 14, cross section 1403 illustrates an example of a different cross section A-A of the pocket space 1311. In 1403, the cross-sectional area of pocket space 1311 may be changed via a change in the clearance (e.g., via one or more techniques described herein) between the riding surface 1315 and the guide surface 1313 and the active surface 1309 of the seed belt 1439.

The seed belt 1439 may comprise a plurality of projections 1441 having tips which collectively define the active surface 1309 which supports the one or more seeds 1387. The plurality of projections 1441 may comprise one or more types of material. The one or more types of material may be a rubber material, a nylon material, an elastomeric material, a felt material, a fiberous material, and/or a polymer material. In one or more scenarios, the plurality of projections 1441 may comprise bristles.

The cross section 1430 illustrates an example of a different cross section B-B of the pocket space 1311. In 1430, the cross-sectional area of pocket space 1311 may be changed via a change in the clearance (e.g., via one or more techniques described herein) between the riding surface 1315 and the guide surface 1313 and the active surface 1309 of the seed belt 1439. In cross section 1430, the one or more seeds 1387 may be motivated into a particular (e.g., desired, tip forward, etc.) orientation in a (e.g., smaller, different) cross-sectional area/pocket size 1311.

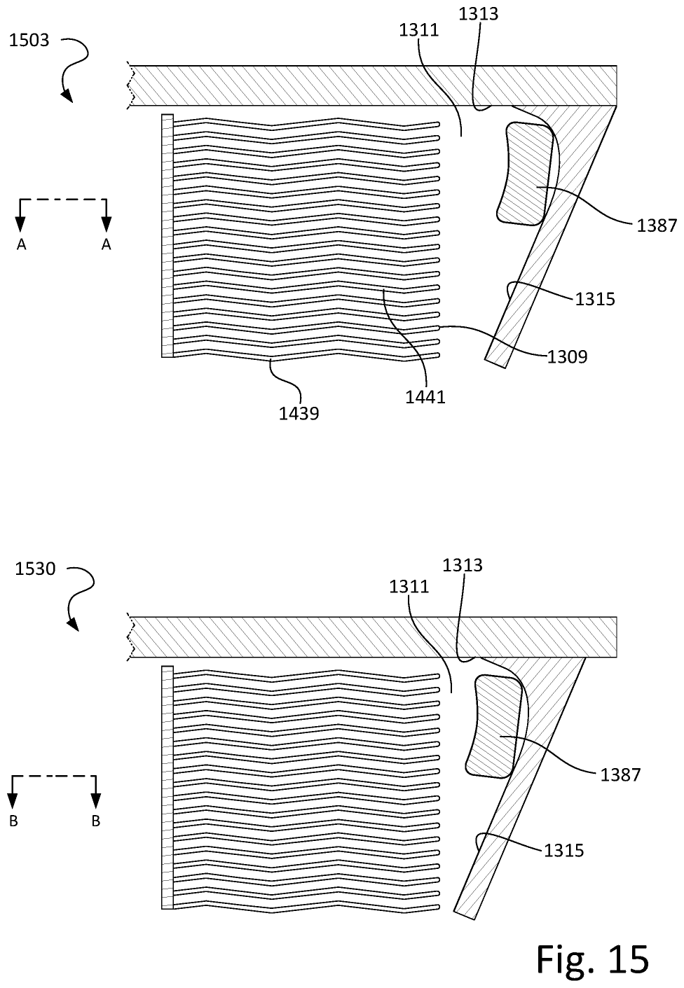

In FIG. 15, cross section 1503 illustrates an example of a different cross section A-A of the pocket space 1311. In 1503, the cross-sectional area of pocket space 1311 may be changed via a change in the clearance (e.g., via one or more techniques described herein) between the riding surface 1315 and the guide surface 1313 and the active surface 1309 of the seed belt 1439.

The cross section 1530 illustrates an example of a different cross section B-B of the pocket space 1311. In 1530, the cross-sectional area of pocket space 1311 may be changed via a change in the clearance (e.g., via one or more techniques described herein) between the riding surface 1315 and the guide surface 1313 and the active surface 1309 of the seed belt 1439. In cross section 1530, the one or more seeds 1387 may be motivated into a particular (e.g., desired, tip forward, etc.) orientation in a (e.g., smaller, different) cross-sectional area/pocket size 1311.

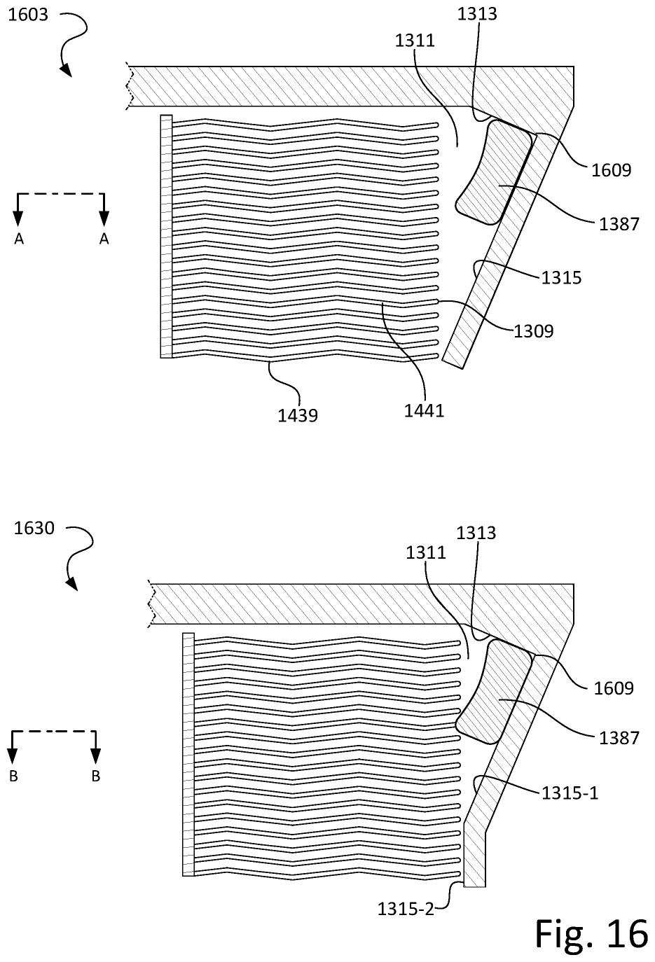

In FIG. 16, cross section 1603 illustrates an example of a different cross section A-A of the pocket space 1311. In 1603, the cross-sectional area of pocket space 1311 may be changed via a change in the geometry among the riding surface 1315 and the guide surface 1313 and the active surface 1309 of the seed belt 1439.

In FIG. 16, cross section 1630 illustrates an example of a different cross section B-B of the pocket space 1311. In 1630, the cross-sectional area of pocket space 1311 may be changed via a change in the geometry among the riding surface 1315 and the guide surface 1313 and the active surface 1309 of the seed belt 1439. In cross section 1630, the one or more seeds 1387 may be motivated into a particular (e.g., desired, tip forward, etc.) orientation in a (e.g., smaller, different) cross-sectional area/pocket size 1311.

In one or more scenarios, an arrangement of the guide surface 1313 and the riding surface 1315 may form a first angle 1609 (e.g., blocked from view by the one or more seeds 1387) between an entire length of the guide surface 1313 and an entire length of the riding surface 1315, such as in cross section 1603, for example.

In one or more scenarios, an arrangement of the guide surface 1313 and the riding surface 1315 may form a first angle 1609 (e.g., blocked from view by the one or more seeds 1387) between an entire length of the guide surface 1313 and at least a partial length 1315-1 of the riding surface 1315-1 and 1315-2, such as in cross section 1630 to produce the B-B variation in the cross-sectional area of seed pocket 1311, for example.

Referring to FIG. 7A to FIG. 16, in one or more scenarios, a rotation of the first seed belt wheel 725 and/or the second seed belt wheel 731 may be adjustable to provide a variation of the seed belt speed. In one or more scenarios, the variation of the seed belt speed may form, at least in part, a variation in a clearance spacing between the interior surface 1307 and the active surface 1309 of the seed belt 935 along at least a portion of the seed delivery path 737. The variation in the clearance spacing between the interior surface 1307 and the active surface 1309 may form, at least in part, the variation in the cross-sectional area of the pocket size/seed pocket 1311 along at least a portion of the seed delivery path 737.

In one or more scenarios, the one or more seeds 1387 may have at least a tip-forward orientation. The variation of the seed belt speed may induce the one or more seeds into the tip-forward orientation. In one or more scenarios, the variation of the seed belt speed may be operably manageable such that the seed belt speed is greater than the seed meter disc speed.

In one or more scenarios, the seed belt housing 739 may be configured to be detachable (not shown) from the seed metering and delivery apparatus. The seed belt housing 739 may be replaceable with one or more other seed belt housings (not shown). The one or more other seed belt housings may be configured to respectively create a variation in a clearance spacing between the interior surface 1307 and the active surface 1309 of the seed belt 935 along at least a portion of the seed delivery path, the variation in the clearance spacing between the interior surface and the active surface forming, at least in part, the variation in the cross-sectional area of the pocket size along at least a portion of the seed delivery path.

Referring to FIG. 7A, in one or more scenarios, the seed meter disc 709 may comprise a rear face (not shown) and a plurality of apertures 757 that may be arranged in a circular pattern spaced inwardly from an outer edge 759 of the seed meter disc 709 and forming the seed supply path 715. One or more, or each aperture 757 of the plurality of apertures 757 may extend through the seed meter disc 709 between the front face 713 and the rear face of the seed meter disc 709 and/or may be configured to retain the one or more seeds 1387 in place on the front face 713 of the seed meter disc 709 by a pressure differential across the plurality of apertures 757. In one or more scenarios, the pressure differential across the plurality of apertures 757 may be lowered proximate to the removal location 717.

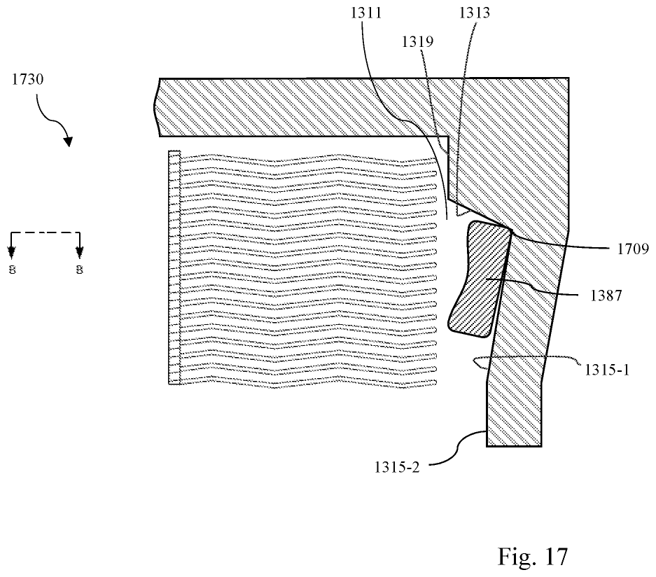

In FIG. 17, cross section 1730 illustrates an example of a different cross section B-B of the pocket space 1311. In 1730, the cross-sectional area of pocket space 1311 may be changed by translating guide surface 1313 by wall 1319. In one or more scenarios, an arrangement of the guide surface 1313 and the riding surface 1315 may form a first angle 1709 (e.g., blocked from view by the one or more seeds 1387) between an entire length of the guide surface 1313 and at least a partial length 1315-1 of the riding surface 1315-1 and 1315-2, such as in cross section 1730 to produce the B-B variation in the cross-sectional area of seed pocket 1311, for example.

Examples of orientation systems include PCT Publication Nos. WO2018013858A1, WO2018013859A1, WO2018013860A2, and WO2018013861A1. In other embodiments, a seed orientation device such as those described in U.S. Patent Publication No. US2020/0367425A1 and US2022/0192079A1 may be used on conjunction with seed dispensing tube 130 to orient the seeds after discharge from seed meter 128 and the seed dispensing tube before deposition in the planting trench. Other systems that support seed orientation and which can be used with the present disclosure are described in U.S. Patent Application Publication Nos. US20200367425A1 and US20220192079A1, PCT Publication Nos. WO2020/227670A2, WO2023/062450A1, WO2023/062463A1, WO2023/062476A1, WO2023/062498A1, WO2023/062499A1, WO2023/062500A1, WO2023/062507A2, WO2023/089408A1, WO2023/105319A1, WO2023/161736A1, WO2023/161737A1, WO2023/161738A1, WO2023/007284A1, and PCT Application Nos. PCT/IB2023/058731, filed 4 Sep. 2023; PCT/IB2023/058732, filed 4 Sep. 2023; PCT/IB2023/058614, filed 31 Aug. 2023; PCT/IB2023/060415, filed 16 Oct. 2023; PCT/IB2023/058733, filed 4 Sep. 2023; PCT/IB2023/061921, filed 27 Nov. 2023; PCT/IB2023/061922, filed 27 Nov. 2023; PCT/IB2023/058735, filed 4 Sep. 2023; PCT/IB2023/058736, filed 4 Sep. 2023; PCT/IB2023/058737, filed 4 Sep. 2023; PCT/IB2023/058738, filed 4 Sep. 2023; PCT/IB2023/058739, filed 4 Sep. 2023; and PCT/IB2023/058740, filed 4 Sep. 2023.

### Examples

The following are nonlimiting examples.

Example 1—a row unit for planting seeds, comprising: a frame configured to be coupled to a toolbar; a seed-trench opening assembly carried by the frame and configured to form a seed trench; a seed-delivery device carried by the frame and configured to deliver seeds to said seed trench, said seed-delivery device having a metering unit having a metering disc configured to receive seeds and output singulated seeds, a seed conveyor and orientation assembly having a conveyor belt that receives said singulated seeds, an impeller that moves said singulated seeds through said conveyor belt, a seed orientation apparatus configured to orient said singulated seed in a predetermined orientation, and a seed exit path configured to deposit said singulated and oriented seed into said seed trench; and a seed-trench closing assembly carried by the frame and configured to close the seed trench over seeds in the seed trench.

Example 2—the row unit of Example 1, wherein said seed orientation apparatus comprises a curved seed path configured to induce a centrifugal force against said singulated seeds.

Example 3—the row unit of Example 2, wherein said curved seed path further comprises a helix.

Example 4—the row unit of Example 3, wherein said curved seed path is banked.

Example 5—the row unit of Example 1, wherein said conveyor belt comprises a guide having in cross section a seed sliding surface and a guide wall angularly offset from said seed sliding surface, said guide and said seed sliding surface configured to engage said singulated seeds while said singulated seeds are moved through said conveyor belt.

Example 6—the row unit of Example 5, wherein said impeller is configured to press said singulated seed toward a junction between and against each of said seed sliding surface and said guide wall while said seed traverses said guide.

Example 7—the row unit of Example 5, wherein said guide comprises a curved seed path configured to induce a centrifugal force against said singulated seed and thereby press said singulated seed toward a junction between and against each of said seed sliding surface and said guide wall while said seed traverses said guide.

Example 8—the row unit of Example 7, wherein said guide further comprises a helix.

Example 9—the row unit of Example 1, wherein said impeller comprises a brush belt having a belt and a plurality of brush bristles protruding therefrom.

Example 10—the row unit of Example 5, wherein said impeller comprises a brush belt having a belt and a plurality of brush bristles protruding therefrom, a first portion of said brush bristles contacting said seed sliding surface, a second portion of said brush bristles contacting said guide wall, and a third portion of said brush bristles contacting said singulated seeds.

Example 11—the row unit of Example 10, further comprising an open space between said plurality of brush bristles and a junction between said seed sliding surface and said guide wall.

Example 12—the row unit of Example 1, wherein said impeller comprises a set of flights.

Example 13—the row unit of Example 1, wherein said seed conveyor and orientation assembly further comprises an air infeed that injects air into a seed path within said seed conveyor and orientation assembly.

Example 14—the row unit of Example 13, wherein said air infeed injects air into said seed orientation apparatus.

Example 15—a seed delivery device, comprising: a metering unit having a metering disc configured to receive seeds and output singulated seeds, a seed conveyor and orientation assembly having a conveyor belt that receives said singulated seeds, an impeller that moves said singulated seeds through said conveyor belt, a seed orientation apparatus configured to orient said singulated seed in a predetermined orientation, and a seed exit path configured to deposit said singulated and oriented seed into a seed trench.

Example 16—the seed delivery device of Example 15, wherein said seed orientation apparatus comprises a helical path.

Example 17—the seed delivery device of Example 15, wherein said seed orientation apparatus comprises a guide having in cross section a seed sliding surface and a guide wall angularly offset from said seed sliding surface, said guide and said seed sliding surface configured to engage said singulated seeds while said singulated seeds are moved through said conveyor belt.

Example 18—a method of planting with a row unit, comprising the steps of: forming a seed trench in soil with the row unit; singulating seeds with a metering disc carried by the row unit; transferring singulated seeds from the metering disc to a seed conveyor and orientation assembly; capturing and conveying said singulated seeds between a guide and said impeller; orienting said singulated seeds; dispensing said singulated and oriented seeds from said seed conveyor and orientation assembly into said seed trench; and closing the seed trench with a seed-trench closing assembly.

Example 19—the method of planting with a row unit of Example 18, wherein said step of orienting said singulated seeds comprises applying a centrifugal force to said singulated seeds.

Example 20—the method of planting with a row unit of Example 18, wherein said step of orienting said singulated seeds comprises injecting air into a seed path.

Example 21—a seed metering and delivery apparatus may comprise a seed meter. The seed meter may comprise a seed meter disc that may be rotatable about a seed meter disc axis. The seed meter disc may comprise at least a front face that may be configured to move one or more seeds at a first seed meter disc speed along a seed supply path to a removal location.

The apparatus may comprise a delivery system. The delivery system may comprise a first seed belt wheel that may be rotatable about a first seed belt wheel axis. The first seed belt wheel may be disposed proximate to the seed meter disc. A second seed belt wheel may be rotatable about a second seed belt wheel axis. The second seed belt wheel may be distally disposed from the first seed belt wheel.

The seed belt may be configured to traverse a seed delivery path around the first seed belt wheel and the second seed belt wheel. The seed belt may have at least an active surface which may support the one or more seeds and a wheel surface. The first seed belt wheel may be positioned adjacent the front face of the seed meter disc such that at least some of the active surface may at least partially cross the seed supply path at the removal location.

The apparatus may comprise a seed belt housing that may be positioned to at least partially cover at least a portion of the seed delivery path opposite the active surface of the seed belt. The seed belt housing may comprise at least an exterior surface and/or an interior surface. The interior surface may be arranged opposite the active surface of the seed belt that may form a pocket space between the active surface of the seed belt and the interior surface. The pocket size may be configured to receive and/or accommodate a change in orientation of the one or more seeds.

The seed belt may be configured to receive the one or more seeds from the front face of the seed meter disc which may be carried along the active surface at a seed belt speed. The seed belt may be configured to convey the one or more seeds along at least a portion of the seed delivery path to a delivery discharge location proximate to the second seed belt wheel.

Example 22—the apparatus of Example 21, wherein the pocket size has a cross-sectional area. The apparatus may be further configured such that a variation in the cross-sectional area occurs along at least a portion of the seed delivery path.

Example 23—the apparatus of Example 22, wherein the interior surface may comprise at least a guide surface and a riding surface. The guide surface and the riding surface may be arranged opposite the active surface of the seed belt further defining the pocket space. The variation in the cross-sectional area may induce, at least in part, the change in orientation of the one or more seeds as the one or more seeds travel along at least a portion of the seed delivery path.

Example 24—the apparatus of Example 23, wherein the seed belt housing may be configured such that an arrangement of the guide surface and the riding surface may form a first angle between an entire length of the guide surface and an entire length of the riding surface.

Example 25—the apparatus of Example 23, wherein the seed belt housing may be configured such that an arrangement of the guide surface and the riding surface may form a first angle between an entire length of the guide wall and at least a partial length of the riding wall.

Example 26—the apparatus of Example 23, wherein the arrangement of the guide surface and the riding surface may form a first geometry. The interior surface may be further configured such that a variation in the arrangement of the guide surface and the riding surface may occur along at least a portion of the seed delivery path. The variation in the arrangement may form a second or more geometries. The second or more geometries may form, at least in part, a second or more cross-sectional areas of the pocket size.

Example 27—the apparatus of any of Example 22 to Example 26, wherein the apparatus may be further configured such that the variation in the cross-sectional area may provide a mechanical manipulation of the one or more seeds inside the pocket space.

Example 28—the apparatus of any of Example 22 to Example 27, wherein the seed belt housing may be configured for variable positioning relative to the seed belt to create a variation in a clearance spacing between the interior surface and the active surface of the seed belt along at least a portion of the seed delivery path. The variation in the clearance spacing between the interior surface and the active surface may form, at least in part, the variation in the cross-sectional area of the pocket size along at least a portion of the seed delivery path.

Example 29—the apparatus of Example 28, further comprising an actuator in mechanical communication with the seed belt housing. The actuator may be configured to create a variation in a spatial displacement of the seed belt housing relative to the seed belt. The variation in the spatial displacement may correspond to the variation in the clearance spacing between the interior surface and the active surface of the seed belt along at least a portion of the seed delivery path.

Example 30—the apparatus of Example 29, wherein the actuator may be an electric, a pneumatic, and/or a hydraulic device.

Example 31—the apparatus of Example 28, further comprising one or more springs in mechanical communication with the seed belt housing. The one or more springs may be configured to create a variation in a spatial displacement of the seed belt housing relative to the seed belt. The variation in the spatial displacement may correspond to the variation in the clearance spacing between the interior surface and the active surface of the seed belt along at least a portion of the seed delivery path.

Example 32—the apparatus of any of Example 22 to Example 31, further comprising a tensioner in mechanical communication with the seed belt. The tensioner may be configured to create a variation in tension on the seed belt. The variation in the tension may form, at least in part, a variation in a clearance spacing between the interior surface and the active surface of the seed belt along at least a portion of the seed delivery path. The variation in the clearance spacing between the interior surface and the active surface may form, at least in part, the variation in the cross-sectional area of the pocket size along at least a portion of the seed delivery path.

Example 33—the apparatus of any of Example 21 to Example 32, wherein a rotation of the first seed belt wheel, and/or the second seed belt wheel, may be adjustable to provide a variation of the seed belt speed.

Example 34—the apparatus of Example 33, wherein the variation of the seed belt speed may form, at least in part, a variation in a clearance spacing between the interior surface and the active surface of the seed belt along at least a portion of the seed delivery path. The variation in the clearance spacing between the interior surface and the active surface may form, at least in part, the variation in the cross-sectional area of the pocket size along at least a portion of the seed delivery path.

Example 35—the apparatus of any of Example 21 to Example 34, wherein the seed belt housing may be configured to be detachable from the apparatus. The seed belt housing may be configured to be replaceable with one or more other seed belt housings. The one or more other seed belt housings may be configured to respectively create a variation in a clearance spacing between the interior surface and the active surface of the seed belt along at least a portion of the seed delivery path. The variation in the clearance spacing between the interior surface and the active surface may form, at least in part, the variation in the cross-sectional area of the pocket size along at least a portion of the seed delivery path.

Example 36—the apparatus of any of Example 21 to Example 35, wherein the seed belt housing may be configured with at least one air port. The at least one air port may be configured to convey an air stream to one or more locations along the seed delivery path between the interior surface and the active surface of the seed belt.

Example 37—the apparatus of any of Example 36, wherein the one or more seeds may have at least a tip-forward orientation. The air stream may impose an air stream force on the one or more seeds as the one or more seeds travel along the seed delivery path. The air stream force may induce the one or more seeds into the tip-forward orientation.

Example 38—the apparatus of any of Example 21 to Example 37, wherein one or more friction inducing textures and/or one or more friction inducing materials may be disposed on the interior surface of the seed belt housing.

Example 39—the apparatus of Example 38, wherein the one or more seeds may have at least a tip-forward orientation. The one or more friction inducing textures and/or the one or more friction inducing materials may impose a moment on the one or more seeds as they travel along the seed delivery path. The moment may induce the one or more seeds into the tip-forward orientation.

Example 40—the apparatus of any of Example 22 to Example 39, wherein the one or more seeds may have at least a tip-forward orientation. The variation in the cross-sectional area along at least a portion of the seed delivery path may induce the one or more seeds into the tip-forward orientation.

Example 41—the apparatus of any of Example 27 to Example 39, wherein the one or more seeds may have at least a tip-forward orientation. The mechanical manipulation may induce the one or more seeds into the tip-forward orientation.

Example 42—the apparatus of any of Example 33 to Example 41, wherein the one or more seeds may have at least a tip-forward orientation. The variation of the seed belt speed may induce the one or more seeds into the tip-forward orientation.

Example 43—the apparatus of any of Example 22 to Example 42, wherein the apparatus may be further configured such that the variation in the cross-sectional area along at least a portion of the seed delivery path may corresponds to a larger cross-sectional area proximate to the first seed belt wheel relative to a smaller cross-sectional area proximate to the second seed belt wheel.

Example 44—the apparatus of any of Example 21 to Example 43, wherein the delivery discharge location may be tangential to the second seed belt wheel. The delivery discharge location may range from +/−45 degrees from a ground reference upon which the apparatus may be deployed.

Example 45—the apparatus of any of Example 21 to Example 44, further comprising a furrow opener that may be configured to open a seed sub-furrow in an agricultural field. The one or more seeds may be conveyed from the delivery discharge location to the seed sub-furrow.

Example 46—the apparatus of Example 45, further comprising a dispensing tube that may be configured to convey the one or more seeds from the delivery discharge location to the seed sub-furrow. The dispensing tube may comprise an upper opening through which the one or more seeds may be received from the delivery discharge location. The dispensing tube may comprise a lower opening through which the one or more seeds may be discharged from the dispensing tube. The dispensing tube may comprise a dispensing track with a continuous curvature that may be disposed in an inner surface of the dispensing tube. The continuous curvature of the dispensing track may be configured to induce the one or more seeds into the tip-forward orientation with at least centrifugal force applied as the one or more seeds travel through the continuous curvature of the dispensing track to the lower opening.

Example 47—the apparatus of Example 46, wherein the dispensing tube may be substantially hollow, and/or free of any internal structures.

Example 48—the apparatus of Example 46, wherein the continuous curvature of the dispensing track may comprise one or more helically shaped sections.

Example 49—the apparatus of any of Example 21 to Example 48, wherein the seed meter disc may rotate in a seed meter disc plane of movement. The first seed belt wheel may rotate in a first seed belt wheel plane of movement. The apparatus may be further configured such that the seed meter disc plane of movement and the first seed belt wheel plane of movement may be substantially parallel to each other, and/or non-intersecting with each other.

Example 50—the apparatus of any of Example 21 to Example 49, wherein the seed meter disc axis and the first seed belt wheel axis may be substantially parallel to each other, and/or non-intersecting with each other.

Example 51—the apparatus of any of Example 21 to Example 50, wherein the seed meter disc may rotate in a seed meter disc plane of movement. The first seed belt wheel may rotate in a first seed belt wheel plane of movement. The apparatus may be further configured such that the seed meter disc plane of movement and the first seed belt wheel plane of movement may be substantially non-parallel to each other, and/or intersecting with each other.

Example 52—the apparatus of any of Example 21 to Example 51, wherein the seed meter disc axis and the first seed belt wheel axis may be substantially non-parallel to each other, and/or intersecting with each other.

Example 53—the apparatus of any of Example 22 to Example 52, wherein the seed meter disc may further comprise a rear face and/or a plurality of apertures that may be arranged in a circular pattern that may be spaced inwardly from an outer edge of the seed wheel and may form the seed path. One or more, or each, aperture of the plurality of apertures may extend through the seed meter disc between the front face and the rear face of the seed meter disc and/or may be configured to retain the one or more seeds in place on the front face of the seed meter disc by a pressure differential across the plurality of apertures.

Example 54—the apparatus of any of Example 36 to Example 51, further comprising an air blower that may be configured to provide the air stream to at least the seed belt housing.

Example 55—the apparatus of any of Example 21 to Example 54, wherein the seed belt may comprise a plurality of projections that may have tips which collectively define the active surface which supports the one or more seeds.

Example 56—the apparatus of Example 55, wherein the plurality of projections may comprise one or more types of material. The one or more types of material may be a rubber material, a nylon material, an elastomeric material, a felt material, a fiberous material, and/or a polymer material.

Example 57—the apparatus of Example 55 or Example 56, wherein the plurality of projections may comprise one or more bristles.

Example 58—the apparatus of any of Example 21 to Example 54, wherein the seed belt may comprise a projection-less surface that may define the active surface which supports the one or more seeds.

Example 59—the apparatus of Example 58, wherein the projection-less surface comprises one or more types of material. The one or more types of material may be a rubber material, a nylon material, an elastomeric material, a felt material, a fiberous material, and/or a polymer material.

Example 60—the apparatus of any of Example 46 to Example 59, wherein the dispensing tube may be configured with a substantially curved outer surface.

Example 61—the apparatus of any of Example 53 to Example 60, wherein the pressure differential across the plurality of apertures may be lowered proximate to the removal location.

Example 62—the apparatus of any of Example 33 to Example 61, wherein the variation of the seed belt speed may be operably manageable such that the seed belt speed may be greater than the seed meter disc speed.

The terminology used herein is for the purpose of describing particular embodiments only and is not intended to be limiting of the invention. As used herein, the term “and/or” includes any and all combinations of one or more of the associated listed items. As used herein, the singular forms “a,”, “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence of addition of one or more other features, steps, operations, elements, components, and/or groups thereof. The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A seed metering and delivery apparatus, comprising:
a seed meter comprising a seed meter disc rotatable about a seed meter disc axis, the seed meter disc comprising at least a front face configured to move one or more seeds at a first seed meter disc speed along a seed supply path to a removal location; and
a delivery system, comprising:
a first seed belt wheel rotatable about a first seed belt wheel axis, the first seed belt wheel disposed proximate to the seed meter disc;
a second seed belt wheel rotatable about a second seed belt wheel axis, the second seed belt wheel distally disposed from the first seed belt wheel;
a seed belt configured to traverse a seed delivery path around the first seed belt wheel and the second seed belt wheel, the seed belt having at least an active surface which supports the one or more seeds and a wheel surface, the first seed belt wheel positioned adjacent the front face of the seed meter disc such that at least some of the active surface at least partially crosses the seed supply path at the removal location; and
a seed belt housing positioned to at least partially cover at least a portion of the seed delivery path opposite the active surface of the seed belt, the seed belt housing comprising at least an exterior surface and an interior surface, the interior surface arranged opposite the active surface of the seed belt forming a pocket space between the active surface of the seed belt and the interior surface, the pocket size configured to receive and accommodate a change in orientation of the one or more seeds, the seed belt configured to:
receive the one or more seeds from the front face of the seed meter disc which are carried along the active surface at a seed belt speed; and
convey the one or more seeds along at least a portion of the seed delivery path to a delivery discharge location proximate to the second seed belt wheel.

2. The apparatus of claim 1, wherein the pocket size has a cross-sectional area, the apparatus being further configured such that a variation in the cross-sectional area occurs along at least a portion of the seed delivery path.

3. The apparatus of claim 2, wherein the interior surface comprises at least a guide surface and a riding surface, the guide surface and the riding surface arranged opposite the active surface of the seed belt further defining the pocket space, and the variation in the cross-sectional area induces, at least in part, the change in orientation of the one or more seeds as the one or more seeds travel along at least a portion of the seed delivery path.

4. The apparatus of claim 3, wherein the seed belt housing is configured such that an arrangement of the guide surface and the riding surface forms a first angle between an entire length of the guide surface and an entire length of the riding surface.

5. The apparatus of claim 3, wherein the seed belt housing is configured such that an arrangement of the guide surface and the riding surface forms a first angle between an entire length of the guide wall and at least a partial length of the riding wall.

6. The apparatus of claim 3, wherein the arrangement of the guide surface and the riding surface forms a first geometry, the interior surface being further configured such that a variation in the arrangement of the guide surface and the riding surface occurs along at least a portion of the seed delivery path, the variation in the arrangement forming a second or more geometries, the second or more geometries forming, at least in part, a second or more cross-sectional areas of the pocket size.

7. The apparatus of claim 2, wherein the apparatus is further configured such that the variation in the cross-sectional area provides a mechanical manipulation of the one or more seeds inside the pocket space.

8. The apparatus of claim 2, wherein the seed belt housing is configured for variable positioning relative to the seed belt to create a variation in a clearance spacing between the interior surface and the active surface of the seed belt along at least a portion of the seed delivery path, the variation in the clearance spacing between the interior surface and the active surface forming, at least in part, the variation in the cross-sectional area of the pocket size along at least a portion of the seed delivery path.

9. The apparatus of claim 8, further comprising an actuator in mechanical communication with the seed belt housing, the actuator configured to create a variation in a spatial displacement of the seed belt housing relative to the seed belt, the variation in the spatial displacement corresponding to the variation in the clearance spacing between the interior surface and the active surface of the seed belt along at least a portion of the seed delivery path.

10. The apparatus of claim 9, wherein the actuator is at least one of: an electric, a pneumatic, or a hydraulic device.

11. The apparatus of claim 8, further comprising one or more springs in mechanical communication with the seed belt housing, the one or more springs configured to create a variation in a spatial displacement of the seed belt housing relative to the seed belt, the variation in the spatial displacement corresponding to the variation in the clearance spacing between the interior surface and the active surface of the seed belt along at least a portion of the seed delivery path.

12. The apparatus of claim 2, further comprising a tensioner in mechanical communication with the seed belt, the tensioner configured to create a variation in tension on the seed belt, the variation in the tension forming, at least in part, a variation in a clearance spacing between the interior surface and the active surface of the seed belt along at least a portion of the seed delivery path, the variation in the clearance spacing between the interior surface and the active surface forming, at least in part, the variation in the cross-sectional area of the pocket size along at least a portion of the seed delivery path.

13. The apparatus of claim 1, wherein a rotation of at least one of: the first seed belt wheel, or the second seed belt wheel, is adjustable to provide a variation of the seed belt speed.

14. The apparatus of claim 13, wherein the variation of the seed belt speed forms, at least in part, a variation in a clearance spacing between the interior surface and the active surface of the seed belt along at least a portion of the seed delivery path, the variation in the clearance spacing between the interior surface and the active surface forming, at least in part, the variation in the cross-sectional area of the pocket size along at least a portion of the seed delivery path.

15. The apparatus of claim 1, wherein the seed belt housing is further configured to:
be detachable from the apparatus; and
replaceable with one or more other seed belt housings, the one or more other seed belt housings configured to respectively create a variation in a clearance spacing between the interior surface and the active surface of the seed belt along at least a portion of the seed delivery path, the variation in the clearance spacing between the interior surface and the active surface forming, at least in part, the variation in the cross-sectional area of the pocket size along at least a portion of the seed delivery path.

16. The apparatus of claim 1, wherein the seed belt housing is configured with at least one air port, the at least one air port configured to convey an air stream to one or more locations along the seed delivery path between the interior surface and the active surface of the seed belt.

17. The apparatus of claim 16, wherein the one or more seeds have at least a tip-forward orientation, the air stream imposes an air stream force on the one or more seeds as the one or more seeds travel along the seed delivery path, and the air stream force induces the one or more seeds into the tip-forward orientation.

18. The apparatus of claim 1, wherein one or more friction inducing textures and/or one or more friction inducing materials are disposed on the interior surface of the seed belt housing.

19. The apparatus of claim 18, wherein the one or more seeds have at least a tip-forward orientation, the one or more friction inducing textures and/or the one or more friction inducing materials impose a moment on the one or more seeds as they travel along the seed delivery path, and the moment induces the one or more seeds into the tip-forward orientation.

20. The apparatus of claim 2, wherein the one or more seeds have at least a tip-forward orientation, and the variation in the cross-sectional area along at least a portion of the seed delivery path induces the one or more seeds into the tip-forward orientation.

21. The apparatus of claim 7, wherein the one or more seeds have at least a tip-forward orientation, and the mechanical manipulation induces the one or more seeds into the tip-forward orientation.

22. The apparatus of claim 13, wherein the one or more seeds have at least a tip-forward orientation, and the variation of the seed belt speed induces the one or more seeds into the tip-forward orientation.

23. The apparatus of claim 2, wherein the apparatus is further configured such that the variation in the cross-sectional area along at least a portion of the seed delivery path corresponds to a larger cross-sectional area proximate to the first seed belt wheel relative to a smaller cross-sectional area proximate to the second seed belt wheel.

24. The apparatus of claim 1, wherein the delivery discharge location is tangential to the second seed belt wheel, and the delivery discharge location ranges from +/−45 degrees from a ground reference upon which the apparatus is deployed.

25. The apparatus of claim 1, further comprising a furrow opener configured to open a seed sub-furrow in an agricultural field, wherein the one or more seeds are conveyed from the delivery discharge location to the seed sub-furrow.

26. The apparatus of claim 25, further comprising a dispensing tube configured to convey the one or more seeds from the delivery discharge location to the seed sub-furrow, the dispensing tube comprising:
an upper opening through which the one or more seeds are received from the delivery discharge location;
a lower opening through which the one or more seeds are discharged from the dispensing tube; and
a dispensing track with a continuous curvature disposed in an inner surface of the dispensing tube, the continuous curvature of the dispensing track configured to induce the one or more seeds into the tip-forward orientation with at least centrifugal force applied as the one or more seeds travel through the continuous curvature of the dispensing track to the lower opening.

27. The apparatus of claim 26, wherein the dispensing tube is at least one of: substantially hollow, or free of any internal structures.

28. The apparatus of claim 26, wherein the continuous curvature of the dispensing track comprises one or more helically shaped sections.

29. The apparatus of claim 1, wherein the seed meter disc rotates in a seed meter disc plane of movement, and the first seed belt wheel rotates in a first seed belt wheel plane of movement, the apparatus being further configured such that the seed meter disc plane of movement and the first seed belt wheel plane of movement are at least one of: substantially parallel to each other, or non-intersecting with each other.

30. The apparatus of claim 1, wherein the seed meter disc axis and the first seed belt wheel axis are at least one of: substantially parallel to each other, or non-intersecting with each other.

31. The apparatus of claim 1, wherein the seed meter disc rotates in a seed meter disc plane of movement, and the first seed belt wheel rotates in a first seed belt wheel plane of movement, the apparatus being further configured such that the seed meter disc plane of movement and the first seed belt wheel plane of movement are at least one of: substantially non-parallel to each other, or intersecting with each other.

32. The apparatus of claim 1, wherein the seed meter disc axis and the first seed belt wheel axis are at least one of: substantially non-parallel to each other, or intersecting with each other.

33. The apparatus of claim 1, wherein the seed meter disc further comprises a rear face and a plurality of apertures arranged in a circular pattern spaced inwardly from an outer edge of the seed wheel and forming the seed path, each aperture of the plurality of apertures extending through the seed meter disc between the front face and the rear face of the seed meter disc and configured to retain the one or more seeds in place on the front face of the seed meter disc by a pressure differential across the plurality of apertures.

34. The apparatus of claim 16, further comprising an air blower configured to provide the air stream to at least the seed belt housing.

35. The apparatus of claim 1, wherein the seed belt comprises a plurality of projections having tips which collectively define the active surface which supports the one or more seeds.

36. The apparatus of claim 35, wherein the plurality of projections comprise one or more types of material, the one or more types of material being one or more of: a rubber material, a nylon material, an elastomeric material, a felt material, a fiberous material, or a polymer material.

37. The apparatus of claim 35, wherein the plurality of projections comprise bristles.

38. The apparatus of claim 1, wherein the seed belt comprises a projection-less surface that defines the active surface which supports the one or more seeds.

39. The apparatus of claim 38, wherein the projection-less surface comprises one or more types of material, the one or more types of material being one or more of: a rubber material, a nylon material, an elastomeric material, a felt material, a fiberous material, or a polymer material.

40. The apparatus of claim 26, wherein the dispensing tube is configured with a substantially curved outer surface.

41. The apparatus of claim 33, wherein the pressure differential across the plurality of apertures is lowered proximate to the removal location.

42. The apparatus of claim 13, wherein the variation of the seed belt speed is operably manageable such that the seed belt speed is greater than the seed meter disc speed.
